(19) United States
(12) Patent Application Publication
(10) Pub. No.: US 2025/0070679 A1
(43) Pub. Date: Feb. 27, 2025

(54) POWER CONVERSION DEVICE

(71) Applicant: TDK CORPORATION, Tokyo (JP)

(72) Inventor: Satoshi TOMIOKA, Tokyo (JP)

(73) Assignee: TDK CORPORATION, Tokyo (JP)

(21) Appl. No.: 18/806,104

(22) Filed: Aug. 15, 2024

(30) Foreign Application Priority Data
Aug. 23, 2023 (JP) 2023-135131

(51) Int. Cl. H02M 3/335; H02M 1/42; H02M 3/00

(52) U.S. Cl. CPC H02M 3/33576; H02M 1/4225; H02M 3/01

(57) ABSTRACT

In a power conversion device, a control circuit sets an output voltage of a boost converter to a first output voltage level or a second output voltage level in accordance with a voltage corresponding to the input voltage, causes an electric current resonant converter to operate in a full-bridge mode as an operating mode when the first output voltage level has been set, and causes the electric current resonant converter to operate in a half-bridge mode as an operating mode when the second output voltage level has been set. The first output voltage level or the second output voltage level is set at a predetermined timing after the input voltage is input and a set operating mode is maintained until a process of setting the first output voltage level or the second output voltage level is reset.

### CROSS-REFERENCE TO RELATED APPLICATION

Priority is claimed on Japanese Patent Application No. 2023-135131, filed Aug. 23, 2023, the content of which is incorporated herein by reference.

### BACKGROUND OF THE INVENTION

### Field of the Invention

The present disclosure relates to a power conversion device.

### Description of Related Art

In a power conversion device including an electric current resonant converter in a stage subsequent to a boost converter, a case where an input voltage of the boost converter can have two or more types of input voltage levels is conceivable. As a specific example, the input voltage level may differ according to a country where the power conversion device is used.

As disclosed in Patent Document 1, in an electric current resonant converter that converts a direct current (DC) input voltage into an alternating current (AC) voltage, a switching process is performed between a switching circuit having a full-bridge configuration and a switching circuit having a half-bridge configuration in accordance with the DC input voltage (see Patent Document 1).

### PATENT DOCUMENTS

[Patent Document 1] Japanese Unexamined Patent Application, First Publication No. H3-289354

### SUMMARY OF THE INVENTION

However, in the conventional technology as described above, efficiency may be reduced when two or more types of input voltage levels can be provided in a power conversion device including the electric current resonant converter in a stage subsequent to a boost converter.

The present disclosure has been made in consideration of such circumstances and an objective of the present disclosure is to provide a power conversion device capable of achieving high efficiency even if an input voltage of a boost converter can have two or more types of input voltage levels in a configuration in which an electric current resonant converter is provided in a stage subsequent to the boost converter.

According to an aspect, there is provided a power conversion device including: a boost converter; an electric current resonant converter connected to a stage subsequent to the boost converter; and a control circuit, wherein the boost converter boosts an input voltage to designate the boosted input voltage as an output voltage and output the output voltage while charging a first output capacitor with the output voltage, wherein the control circuit controls the boost converter on the basis of a voltage detected by an output voltage detection circuit configured to detect a voltage of the first output capacitor, wherein the control circuit sets the output voltage of the boost converter to a first output voltage level or a second output voltage level in accordance with a voltage detected by an input voltage detection circuit configured to detect a voltage corresponding to the input voltage, causes the electric current resonant converter to operate in a full-bridge mode as an operating mode when the first output voltage level has been set, and causes the electric current resonant converter to operate in a half-bridge mode as an operating mode when the second output voltage level has been set, wherein the output voltage detection circuit and the input voltage detection circuit are a common circuit or separate circuits, and wherein the first output voltage level or the second output voltage level is set at a predetermined timing after the input voltage is input and a set operating mode is maintained until a process of setting the first output voltage level or the second output voltage level is reset.

According to the present disclosure, a power conversion device can achieve high efficiency even if an input voltage of a boost converter can have two or more types of input voltage levels in a configuration in which an electric current resonant converter is provided in a stage subsequent to the boost converter.

### BRIEF DESCRIPTION OF THE DRAWINGS

FIG. 1 is a diagram showing an example of a configuration of a circuit of a power conversion system according to a first embodiment.

FIG. 2A is a diagram showing an example of switching loss of a switching element.

FIG. 2B is a diagram showing another example of the switching loss of the switching element.

FIG. 2C is a diagram showing yet another example of the switching loss of the switching element.

FIG. 3 is a diagram showing an example of switching loss and conduction loss of the switching element.

FIG. 4A is a diagram showing an example of a relationship between an operating frequency and an output voltage ratio of an electric current resonant converter.

FIG. 4B is a diagram showing another example of a relationship between an operating frequency and an output voltage ratio of the electric current resonant converter.

FIG. 5A is a diagram showing an example of a relationship between an AC input voltage and an output voltage for describing switching between a full-bridge operation and a half-bridge operation according to the embodiment.

FIG. 5B is a diagram showing a state of the half-bridge operation in the electric current resonant converter according to the embodiment.

FIG. 5C is a diagram showing a state of the full-bridge operation in the electric current resonant converter according to the embodiment.

FIG. 5D is a diagram showing an example of a voltage applied to a primary side of a transformer during the half-bridge operation according to the embodiment.

FIG. 5E is a diagram showing an example of a voltage applied to the primary side of the transformer during the full-bridge operation according to the embodiment.

FIG. 6A is a diagram showing an example of a drive signal switching circuit according to the embodiment.

FIG. 6B is a diagram showing an example of an input/output signal of the drive signal switching circuit according to the embodiment.

FIG. 7 is a diagram showing an example of a configuration of a circuit of a power conversion system according to a second embodiment.

FIG. 8 is a diagram showing a processing flow representing an example of a boost voltage selection process according to the second embodiment.

FIG. 9A is a diagram showing an example of a configuration of a circuit of a power conversion system according to a third embodiment.

FIG. 9B is a diagram showing a table showing an example of a relationship of an input voltage, an output voltage of a boost converter, and an operating mode of an electric current resonant converter according to the third embodiment.

FIG. 10 is a diagram showing an example of a configuration of a circuit of a power conversion system according to a fourth embodiment.

FIG. 11 is a diagram showing an example of a configuration of a circuit of a power conversion system according to a fifth embodiment.

FIG. 12 is a diagram showing an example of a configuration of a circuit of a power conversion system according to a sixth embodiment.

### DETAILED DESCRIPTION OF THE INVENTION

Hereinafter, embodiments of the present disclosure will be described with reference to the drawings.

### First Embodiment

A first embodiment will be described.

### [Power Conversion System]

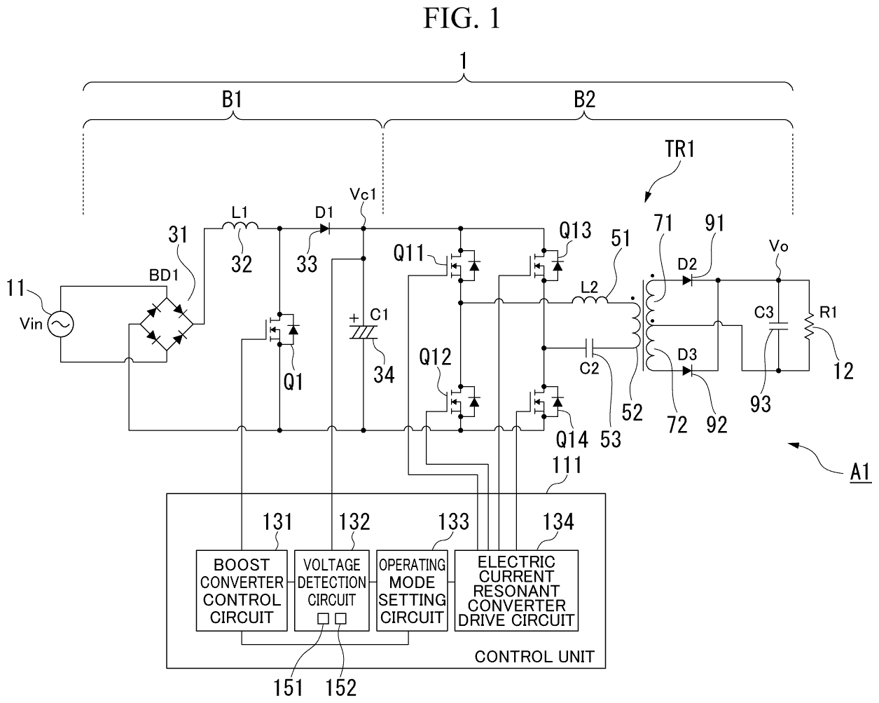

FIG. 1 is a diagram showing an example of a configuration of a circuit of a power conversion system A1 according to the first embodiment.

The power conversion system A1 includes a power conversion device 1, a single-phase alternating current (AC) power supply 11, and a resistor 12.

The power conversion device 1 includes a boost converter B1, an electric current resonant converter B2, and a control circuit 111.

In the present embodiment, the electric current resonant converter B2 is of an inductor-inductor-capacitor (LLC) type.

The electric current resonant converter B2 is connected to a stage subsequent to the boost converter B1.

In the present embodiment, a case where the input voltage of the boost converter B1 is single-phase AC voltage is shown.

Although a case where the AC power supply 11 and the resistor 12 are circuit elements outside of the power conversion device 1 is shown in the present embodiment, a configuration in which one or both of the AC power supply 11 and the resistor 12 are circuit elements inside of the power conversion device 1 may be used as another example.

For example, when both the AC power supply 11 and the resistor 12 are circuit elements inside of the power conversion device 1, the power conversion system A1 and the power conversion device 1 according to the present embodiment are equivalent.

The boost converter B1 includes a diode bridge 31, an inductor 32, a diode 33, a capacitor 34, and a metal oxide semiconductor field effect transistor (MOSFET) Q1 that is a switching element.

The electric current resonant converter B2 includes four MOSFETs Q11 to Q14, which are switching elements, an inductor 51, a primary winding 52, a capacitor 53, secondary windings 71 and 72, two diodes 91 and 92, and a capacitor 93.

The control circuit 111 includes a boost converter control circuit 131, a voltage detection circuit 132, an operating mode setting circuit 133, and an electric current resonant converter drive circuit 134.

The voltage detection circuit 132 includes an input voltage detection circuit 151 and an output voltage detection circuit 152.

Here, a transformer TR1 includes the primary winding 52 and the secondary windings 71 and 72.

In the present embodiment, the secondary windings 71 and 72 are divided into two parts with respect to a point of a center tap according to a center tap method and referred to as the secondary winding 71 and the secondary winding 72 for convenience of description. The secondary winding 71 and the secondary winding 72 may be integrated.

Moreover, each of the MOSFETs Q1 and Q11 to Q14, which are switching elements of the present embodiment, is a type of power semiconductor element.

In addition, in the present embodiment (and subsequent embodiments), a MOSFET body diode is also illustrated.

Moreover, switching elements are not limited to MOSFETs, and, for example, power semiconductor elements such as bipolar transistors (or unipolar transistors), gallium nitride transistors (GaN transistors), insulated gate bipolar transistors (IGBTs), or silicon carbide field effect transistors (SiCFETs) may be used.

### <Circuit Connection Relationship>

Two terminals among four terminals provided in the diode bridge 31 are connected to the two terminals of the AC power supply 11.

One of the other two terminals provided in the diode bridge 31 is connected to one end of the inductor 32.

The other of the other two terminals provided in the diode bridge 31, a source of the MOSFET Q1, one end of the capacitor 34, a source of the MOSFET Q12, and a source of the MOSFET Q14 are connected.

The other end of the inductor 32, an anode of the diode 33, and a drain of the MOSFET Q1 are connected.

A cathode of the diode 33, a drain of the MOSFET Q11, a drain of the MOSFET Q13, and the other end of the capacitor 34 are connected.

A source of the MOSFET Q11, a drain of the MOSFET Q12, and one end of the inductor 51 are connected.

The other end of the inductor 51 and one end of the primary winding 52 are connected.

The other end of the primary winding 52 and one end of the capacitor 53 are connected.

The other end of the capacitor 53, a source of the MOSFET Q13, and a drain of the MOSFET Q14 are connected.

One end of the secondary winding 71 and an anode of the diode 91 are connected.

One end of the secondary winding 72 and an anode of the diode 92 are connected.

A cathode of the diode 91, a cathode of the diode 92, one end of the capacitor 93, and one end of the resistor 12 are connected.

The other end of the secondary winding 71 and the other end of the secondary winding 72 are a common end and the common end, the other end of the capacitor 93, and the other end of the resistor 12 are connected.

Thus, in the present embodiment, the electric current resonant converter B2 includes a leg in which the MOSFET Q11 and the MOSFET Q12 are connected in series, a leg in which the MOSFET Q13 and the MOSFET Q14 are connected in series, the transformer TR1 having the primary winding 52 and the secondary windings 71 and 72, a resonant inductor (the inductor 51), a resonant capacitor (the capacitor 53), and a rectification circuit (a circuit including the diodes 91 and 92).

These two legs are connected in parallel.

In a circuit of a primary side (a primary circuit) of the transformer TR1, both ends of the primary winding 52 are connected to a connection point between the MOSFET Q11 and the MOSFET Q12 and a connection point between the MOSFET Q13 and the MOSFET Q14 via the resonant inductor (the inductor 51) and the resonant capacitor (the capacitor 53).

In a circuit of a secondary side (a secondary circuit) of the transformer TR1, both ends of the secondary windings 71 and 72 are connected to the input terminals (the anode of the diode 91 and the anode of the diode 92) of the rectification circuit.

The input voltage detection circuit 151 detects a voltage corresponding to the input voltage (Vin) for the power conversion device 1 (the boost converter B1). In the present embodiment, the input voltage detection circuit 151 has a function of detecting a voltage corresponding to a potential at the other end of the capacitor 34 (a potential of the cathode of the diode 33). The input voltage detection circuit 151 detects a voltage applied between both ends of the capacitor 34 as the voltage.

The output voltage detection circuit 152 detects the output voltage. In the present embodiment, the output voltage detection circuit 152 has a function of detecting a voltage corresponding to the potential at the other end of the capacitor 34 (the potential of the cathode of the diode 33). The output voltage detection circuit 152 detects a voltage applied between both ends of the capacitor 34 as the voltage.

In addition, instead of detection, it may also be referred to as measurement or instrumentation.

Here, the input voltage detection circuit 151 may be able to detect a voltage corresponding to an input voltage (Vin). As another example, the input voltage detection circuit 151 may detect a voltage corresponding to a potential between one end of the AC power supply 11 and the diode bridge 31 or may detect a voltage corresponding to a potential between the diode bridge 31 and the inductor 32.

In the present embodiment, the input voltage detection circuit 151 detects a voltage to be referred to so that an input voltage system (a 200 VAC system or a 400 VAC system in the present embodiment) is determined.

In addition, a reference value (for example, a threshold value) related to the voltage is set in accordance with the voltage detected by the input voltage detection circuit 151. That is, the threshold value can change with the voltage detected as a voltage corresponding to the input voltage.

Moreover, the output voltage detection circuit 152 detects a voltage (output voltage) to be referred to so that the output voltage of the boost converter B1 is kept uniform.

For this reason, the input voltage detection circuit 151 may detect a voltage at a point different from that of the voltage detected by the output voltage detection circuit 152.

In addition, in the present embodiment, because the input voltage detection circuit 151 and the output voltage detection circuit 152 detect the same voltage, they may be shared.

The boost converter control circuit 131 has a function of outputting a control voltage to a gate of the MOSFET Q1.

In the present embodiment, the boost converter control circuit 131 performs a control process of maintaining the output voltage of the boost converter B1 at a predetermined value on the basis of a voltage detected by the output voltage detection circuit 152.

In the present embodiment, the predetermined value can be switched to a plurality of values (380 V and 760 V).

The operating mode setting circuit 133 has a function of setting the operating mode.

The electric current resonant converter drive circuit 134 has a function of outputting a control voltage to a gate of the MOSFET Q11 in accordance with the operating mode and a function of outputting the control voltage to a gate of the MOSFET Q12 in accordance with the operating mode.

Moreover, the electric current resonant converter drive circuit 134 has a function of outputting a control voltage to a gate of the MOSFET Q13 in accordance with the operating mode and a function of outputting the control voltage to a gate of the MOSFET Q14 in accordance with the operating mode.

In the present embodiment, the input voltage detection circuit 151 detects a voltage corresponding to the input voltage (Vin), the operating mode setting circuit 133 sets the operating mode on the basis of the detected voltage, and each of the boost converter control circuit 131 and the electric current resonant converter drive circuit 134 operate on the basis of the set operating mode. At this time, the operating mode setting circuit 133 decides a target boost voltage and notifies the boost converter control circuit 131 of the decided target boost voltage. The boost converter control circuit 131 controls the MOSFET Q1 (feedback control) so that the output voltage is uniform (the target boost voltage) on the basis of the detected voltage from the output voltage detection circuit 152.

Here, the control circuit 111 may include, for example, a microcomputer or the like.

Although the boost converter control circuit 131, the voltage detection circuit 132, the operating mode setting circuit 133, and the electric current resonant converter drive circuit 134 are shown inside of the control circuit 111 for convenience of description in the present embodiment, the internal functions of the control circuit 111 may not necessarily be clearly separated.

Moreover, as another example, the functions of the control circuit 111 may be separated into a plurality of circuit units.

### <Example of Usage Environment of Power Conversion Device>

An example of an environment in which the power conversion device 1 according to the present embodiment is used will be described.

In the present embodiment, an environment in which the input voltage for the boost converter B1 of the power conversion device 1 can have two or more types of input voltage levels will be assumed and described.

As this environment, for example, a case where the voltage of the power supply for supplying the input voltage for the boost converter B1 of the power conversion device 1 may differ depending on the country or the like is conceivable.

In the present embodiment, a case where a voltage of a public power supply of a first country is a system having an AC voltage of 200 V (a 200 VAC system) and a voltage of a public power supply of a second country different from the first country is a system having an AC voltage of 400 V (a 400 VAC system) is shown as an example.

Here, in the 200 VAC system, for example, 200 to 240 VAC is supplied.

Moreover, in the 400 VAC system, for example, 400 to 480 VAC is supplied.

Thus, in the present embodiment, the input voltage for the boost converter B1 of the power conversion device 1 can be a wide input.

As a specific example, when the power conversion device 1 is used in the first country, a power supply of the 200 VAC system is connected to the power conversion device 1 (the boost converter B1) and the power conversion device 1 is activated.

In this case, in the present embodiment, the boost converter B1 is configured to designate a target boost voltage of 380 V and output a DC voltage of 380 V and the electric current resonant converter B2 is configured to perform an operation of a full-bridge mode as an operating mode (a full-bridge operation).

Moreover, when the power conversion device 1 is used in the second country, a power supply of the 400 VAC system is connected to the power conversion device 1 (the boost converter B1) and the power conversion device 1 is activated.

In this case, in the present embodiment, the boost converter B1 is configured to designate a target boost voltage of 760 V and output a DC voltage of 760 V and the electric current resonant converter B2 is configured to perform an operation of a half-bridge mode as an operating mode (a half-bridge operation).

Here, in the present embodiment, the power conversion device 1 operates while maintaining the set operating mode without changing the set operating mode until a predetermined reset operation is performed after the power conversion device 1 is activated.

When the reset operation is performed, for example, the input voltage (or input power or the like) for the power conversion device 1 (the boost converter B1) is less than or equal to a predetermined value for a predetermined time period or more. The predetermined time period or more is, for example, determined in advance, and a time period for allowing the reset operation to be performed is set as in a case where a breaker is turned off or the like.

That is, for example, the breaker for the power supply that supplies the input voltage for the power conversion device 1 (the boost converter B1) is turned off or the like, and therefore the reset operation is performed in the case where the input voltage for the power conversion device 1 (the boost converter B1) is substantially blocked.

In addition, the power conversion device 1 may be configured so that the operation is not treated as a reset operation when there is an instantaneous power failure in which the power supply is instantaneously turned off.

Here, although input voltage levels of the 200 VAC system and the 400 VAC system are exemplified in the present embodiment, other input voltage levels may be used as the plurality of input voltage levels.

Although a case where the output voltage level of the boost converter B1 is either 380 V or 760 V is exemplified in the present embodiment, other output voltage levels may be used as the output voltage level.

For example, voltages of a ratio of 1:2 are used like 200 V and 400 V or 380 V and 760 V in the present embodiment, but this ratio may deviate as long as any practical problems are not caused in another example. For example, a ratio such as 0.9:2 or 1:2.1 may be used.

Although a case where the input voltage for the power conversion device 1 (the boost converter B1) can have two or more types of input voltage levels depending on the country is exemplified in the present embodiment, the present disclosure may be applied when two types of input voltage levels can be obtained due to factors other than the country.

Although a case where the input voltage for the power conversion device 1 (the boost converter B1) can have two types of input voltage levels will be described in the present embodiment, the present disclosure may be applied when the input voltage can have three or more types of input voltage levels.

Hereinafter, the power conversion device 1 according to the present embodiment will be described in more detail.

### Description of Related Technologies

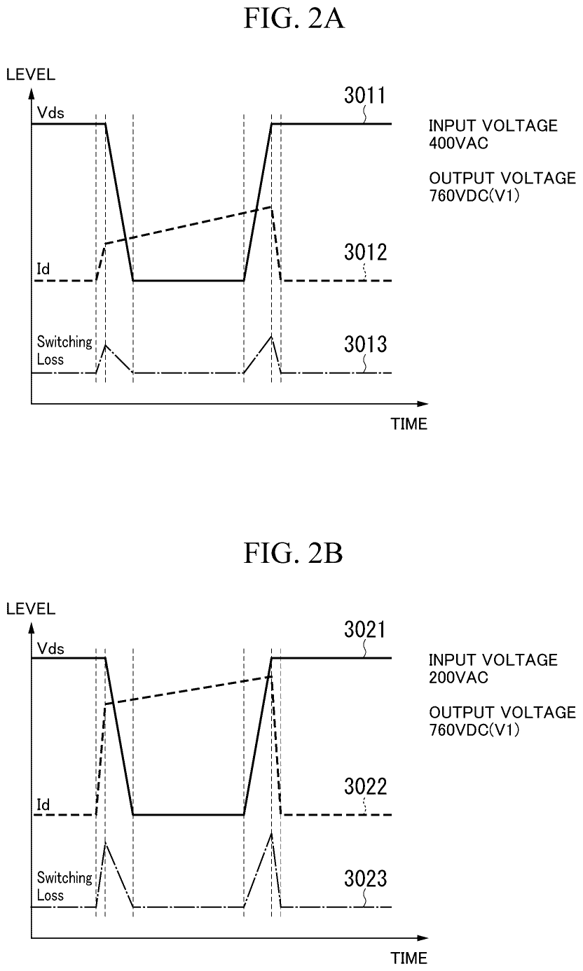

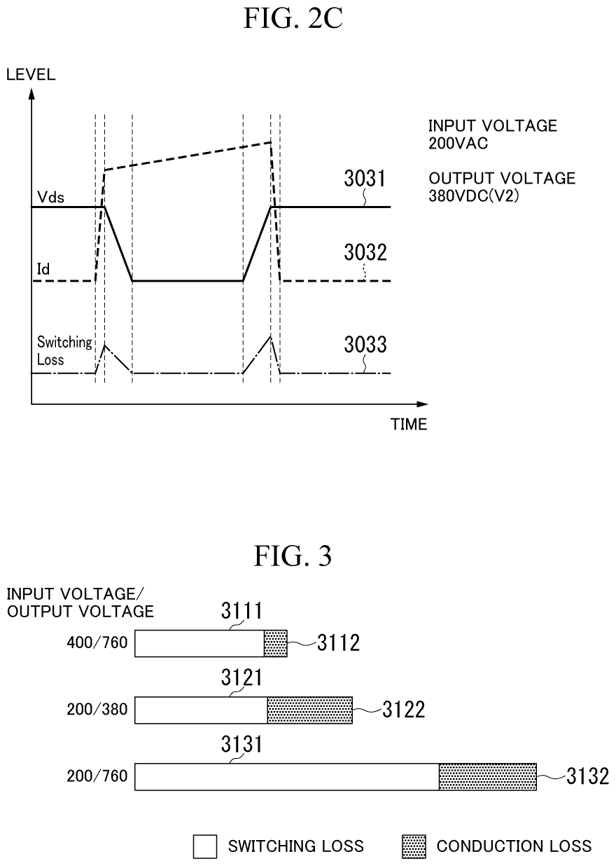

First, the related technologies will be described with reference to FIGS. 2A to 2C, 3, 4A, and 4B.

FIG. 2A is a diagram showing an example of switching loss of a switching element (the MOSFET Q1 in this example).

In the example of FIG. 2A, a case where the input voltage of the boost converter is 400 VAC and the output voltage of the boost converter is 760 VDC is shown.

In the graph shown in FIG. 2A, the horizontal axis represents time and the vertical axis represents a level of each index.

In the graph, a characteristic of a voltage 3011 (Vds) between the drain and the source of the switching element (the MOSFET Q1 in this example), a characteristic of a drain current 3012 (Id) of the switching element (the MOSFET Q1 in this example), and a characteristic of switching loss 3013 occurring therefrom are shown as each index.

FIG. 2B is a diagram showing another example of the switching loss of the switching element (the MOSFET Q1 in this example).

In the example of FIG. 2B, a case where the input voltage of the boost converter is 200 VAC and the output voltage of the boost converter is 760 VDC is shown.

In the graph shown in FIG. 2B, the horizontal axis represents time and the vertical axis represents a level of each index.

In the graph, a characteristic of a voltage 3021 (Vds) between the drain and the source of the switching element (the MOSFET Q1 in this example), a characteristic of a drain current 3022 (Id) of the switching element, and a characteristic of switching loss 3023 occurring therefrom are shown as each index.

FIG. 2C is a diagram showing yet another example of the switching loss of the switching element (the MOSFET Q1 in this example).

In the example of FIG. 2C, a case where the input voltage of the boost converter is 200 VAC and the output voltage of the boost converter is 380 VDC is shown.

In the graph shown in FIG. 2C, the horizontal axis represents time and the vertical axis represents a level of each index.

In the graph, a characteristic of a voltage 3031 (Vds) between the drain and the source of the switching element (the MOSFET Q1 in this example), a characteristic of a drain current 3032 (Id) of the switching element, and a characteristic of switching loss 3033 occurring therefrom are shown as each index.

Here, it is necessary to set the output voltage of the boost converter to a voltage higher than an upper limit of an input range. However, in the case of a wide input, if the voltage is boosted from a low input voltage, the switching loss increases and the efficiency decreases.

For example, when the input voltage is 200 VAC to 480 VAC, the boost voltage (Vc1) of the boost converter is about 760 V (Vc1>480×1.1×1.412=747 V).

Because the switching loss of the semiconductor is proportional to (voltage×current), switching loss Psw is proportional to (output voltage Vc1×input current Iin). In the case of hard switching, the switching loss when the input voltage is 200 Vis twice the switching loss when the input voltage is 400 V (see, for example, FIGS. 2A and 2B).

FIG. 3 is a diagram showing an example of the switching loss and conduction loss of the switching element (the MOSFET Q1 in this example).

In FIG. 3, the degrees of switching loss 3111 and conduction loss 3112 when the input voltage is 400 VAC and the output voltage is 760 VDC, the degrees of switching loss 3121 and conduction loss 3122 when the input voltage is 200 VAC and the output voltage is 380 VDC, and the degrees of switching loss 3131 and conduction loss 3132 when the input voltage is 200 VAC and the output voltage is 760 VDC are shown.

In addition, the units of switching loss and conduction loss are, for example, watts.

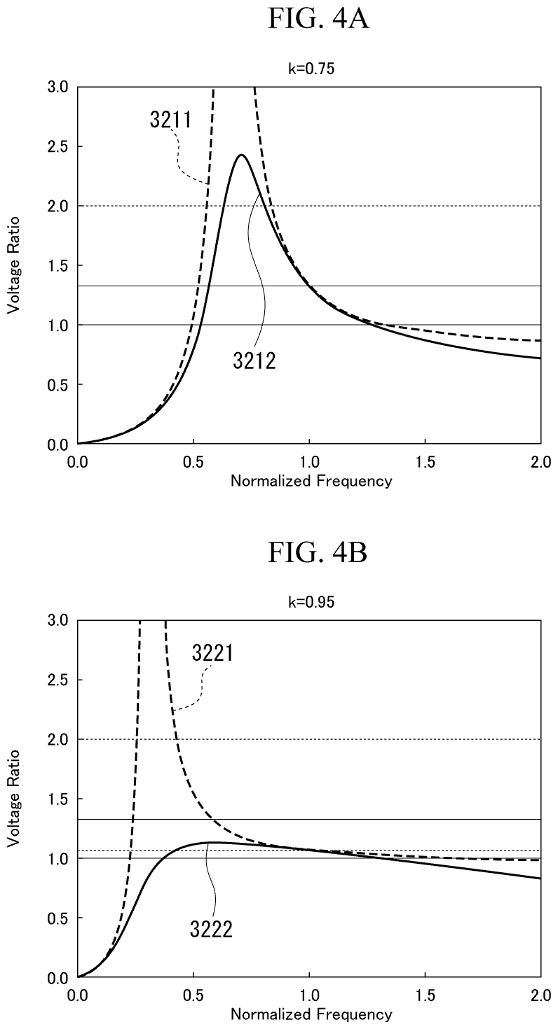

FIG. 4A is a diagram showing an example of the relationship between the operating frequency and the output voltage ratio of an electric current resonant converter.

In FIG. 4A, a case where a coupling coefficient k of the transformer is k=0.75 is shown.

In the graph shown in FIG. 4A, the horizontal axis represents an operating frequency (a normalized frequency) of the electric current resonant converter and the vertical axis represents an output voltage ratio (output voltage Vo/input voltage Vi) of the electric current resonant converter. Here, the input voltage Vi for the electric current resonant converter is equal to the output voltage Vc1 from the previous-stage boost converter.

In FIG. 4A, a low-load characteristic 3211 and a high-load characteristic 3212 are shown with respect to the relationship between the operating frequency and the output voltage ratio of the electric current resonant converter.

Here, in the example of FIG. 4A, the resonant frequency is set to 1.0.

FIG. 4B is a diagram showing another example of a relationship between an operating frequency and an output voltage ratio of the electric current resonant converter.

FIG. 4B shows a case where the coupling coefficient k of the transformer is k=0.95.

In the graph shown in FIG. 4B, the horizontal axis represents an operating frequency (a normalized frequency) of the electric current resonant converter and the vertical axis represents an output voltage ratio (output voltage Vo/input voltage Vi) of the electric current resonant converter.

In FIG. 4B, a low-load characteristic 3221 and a high-load characteristic 3222 are shown with respect to the relationship between the operating frequency and the output voltage ratio of the electric current resonant converter.

Here, in the example of FIG. 4B, the resonant frequency is set to 1.0.

Here, when the output voltage of the boost converter is set to two levels of 380 V and 760 V, the electric current resonant converter (a DC-DC converter) in the subsequent stage will operate using a range thereof as the input voltage, but the efficiency decreases when the electric current resonant converter is set in a wide input in general.

As shown in the example of FIG. 4A, when the coupling coefficient k of the transformer is small, because it is possible to change the frequency and change the output voltage ratio twice or more, the output voltage of the electric current resonant converter can be kept uniform even if the voltage of the boost converter changes twice. However, when the coupling coefficient k is small, the excitation current of the transformer increases relatively and the efficiency decreases.

On the other hand, as shown in the example of FIG. 4B, when the coupling coefficient k of the transformer is large, the excitation current can be reduced and high efficiency can be achieved, but a voltage adjustment range is narrow and cannot correspond to the output voltage range of the boost converter. However, even if the coupling coefficient k is large, load fluctuation is substantially absent if the operating frequency is fixed at the resonant frequency (around the contact between the low-load characteristic 3221 and the high-load characteristic 3222).

### Example of Control of Electric Current Resonant Converter in Present Embodiment

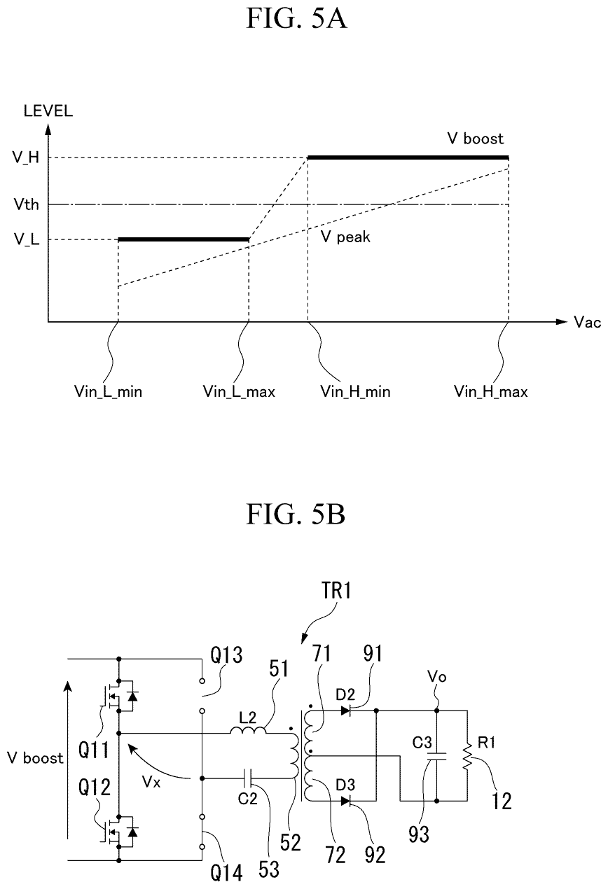

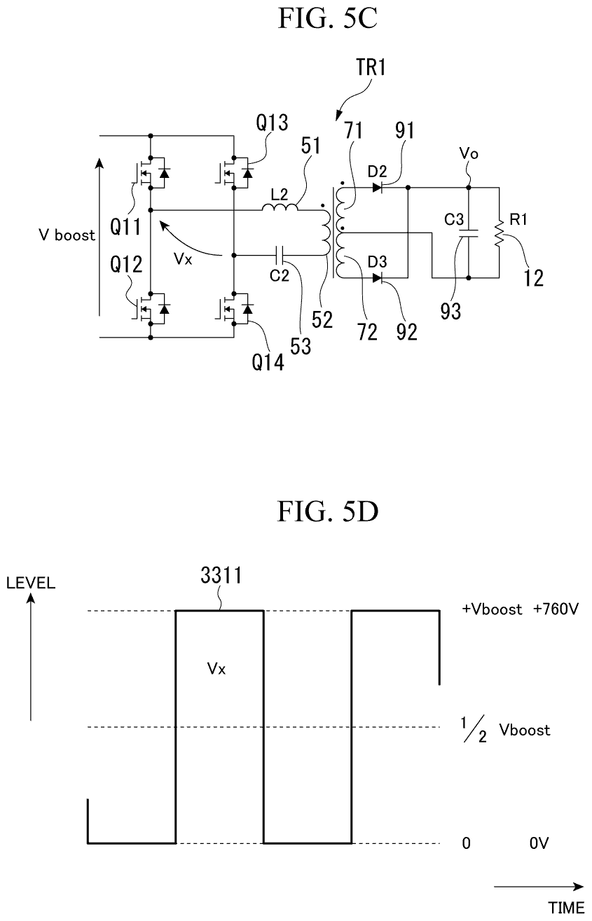

Next, an example of control of the electric current resonant converter B2 in the present embodiment will be described with reference to FIGS. 5A to 5E.

In the power conversion device 1 according to the present embodiment, the boost voltage (the output voltage) is 760 V in a system in which the input voltage of the boost converter B1 is 400 VAC (a 400 VAC system). On the other hand, in the power conversion device 1 according to the present embodiment, the boost voltage (the output voltage) is 380 V (=760 V×½) in a system in which the input voltage of the boost converter B1 is 200 VAC (a 200 VAC system).

Thereby, in the power conversion device 1 according to the present embodiment, the switching loss can be substantially equal between the 200 VAC system and the 400 VAC system (see, for example, FIGS. 2A and 2C).

Moreover, in the power conversion device 1 according to the present embodiment, the MOSFETs Q11 to Q14 are controlled so that the primary side of the electric current resonant converter B2 has a full-bridge configuration when the input voltage of the boost converter B1 is a low level (Vin_L) and the primary side of the electric current resonant converter B2 has a half-bridge configuration when the input voltage of the boost converter B1 is a high level (Vin_H).

Here, when an input voltage (Vboost) of the electric current resonant converter B2 is the high level, the half-bridge operation is set on the primary side and therefore an amplitude of a voltage on the primary side of the transformer TR1 is equal to the amplitude of the full-bridge operation at the low level and the output voltage is also equal.

Because the input voltage (Vboost) is uniform even if the AC input voltage (Vac) or load current fluctuates due to the control of the boost converter B1, for example, the output voltage (Vo) of the electric current resonant converter B2 can be stabilized without using feedback control by fixing the operating frequency to the resonant frequency (or in the vicinity thereof).

FIG. 5A is a diagram showing an example of a relationship between an AC input voltage and an output voltage for describing switching between a full-bridge operation and a half-bridge operation according to the embodiment.

In the graph shown in FIG. 5A, the horizontal axis represents an AC input voltage (Vac) of the boost converter B1 and the vertical axis represents an output voltage of the boost converter B1 (equal to an input voltage of the electric current resonant converter B2).

In FIG. 5A, a voltage range from a minimum value Vin_L_min to a maximum value Vin_L_max is shown as a voltage range when the AC input voltage (Vac) is a low level (Vin_L).

Moreover, in FIG. 5A, a voltage range from a minimum value Vin_H_min to a maximum value Vin_H_max is shown as a voltage range when the AC input voltage (Vac) is a high level (Vin_H).

Here, Vin_L_max<Vin_H_min.

When the AC input voltage (Vac) is in a voltage range from the minimum Vin_L_min of the low level to the maximum Vin_L_max of the low level, the output voltage of the boost converter B1 becomes a low-level output voltage (V_L).

On the other hand, when the AC input voltage (Vac) is in a voltage range from the minimum value Vin_H_min of the high level to the maximum value Vin_H_max of the high level, the output voltage of the boost converter B1 becomes a high-level output voltage (V_H).

In the present embodiment, a threshold voltage Vth is set between the low-level output voltage (V_L) and the high-level output voltage (V_H).

In addition, the threshold voltage Vth, for example, may be at the midpoint between the low-level output voltage (V_L) and the high-level output voltage (V_H) (or in the vicinity thereof) or may be at another point.

FIG. 5B is a diagram showing a state of a half-bridge operation in the electric current resonant converter according to the embodiment.

FIG. 5C is a diagram showing a state of a full-bridge operation in the electric current resonant converter according to the embodiment.

In FIGS. 5B and 5C, an example of the control of the electric current resonant converter B2 is shown for convenience of description.

In the present embodiment, when the input voltage of the electric current resonant converter B2 is a high level (V_H), the electric current resonant converter B2 is controlled so that the half-bridge operation is performed as shown in FIG. 5B. In addition, in the present embodiment, the high level (V_H) is 760 V.

Specifically, the control circuit 111 (the operating mode setting circuit 133 and the electric current resonant converter drive circuit 134) performs a control process so that the MOSFET Q13 is in an open state, the MOSFET Q14 is in a conductive state, and the half-bridge operation is performed by the MOSFET Q11 and the MOSFET Q12.

On the other hand, in the present embodiment, when the input voltage of the electric current resonant converter B2 is the low level (V_L), the electric current resonant converter B2 is controlled so that the full-bridge operation is performed as shown in FIG. 5C. In addition, in the present embodiment, the low level (V_L) is 380 V.

Specifically, the control circuit 111 (the operating mode setting circuit 133 and the electric current resonant converter drive circuit 134) performs a control process so that the full-bridge operation is performed by the four MOSFETs Q11 to Q14.

FIG. 5D is a diagram showing an example of a voltage applied to the primary side of the transformer TR1 during the half-bridge operation according to the embodiment.

In FIG. 5D, an example of a voltage Vx that is a voltage applied to the primary side of the transformer TR1 (a voltage 3311 applied between both ends of a portion including the inductor 51, the primary winding 52, and the capacitor 53 in the present embodiment) during the half-bridge operation shown in FIG. 5B is shown.

Specifically, the voltage applied to the primary side is a periodic pulsed voltage 3311.

A level of the voltage 3311 has a state of two values of 0 V and +760 V (Vboost). If the midpoint of a range of these voltages (½×Vboost) is designated as a reference, the pulse is at a level of +380V.

FIG. 5E is a diagram showing an example of a voltage applied to the primary side of the transformer TR1 during the full-bridge operation according to the embodiment.

In FIG. 5E, an example of a voltage Vx that is a voltage applied to the primary side of the transformer TR1 (a voltage 3312 applied between both ends of a portion including the inductor 51, the primary winding 52, and the capacitor 53 in the present embodiment) during the full-bridge operation shown in FIG. 5C is shown.

Specifically, the voltage applied to the primary side is a periodic pulsed voltage 3312.

The level of the voltage 3312 has a state of two values of −380 V (−Vboost) and +380 V (+Vboost). This is a pulse at a level of +380 V.

### <Drive Signal Switching Circuit>

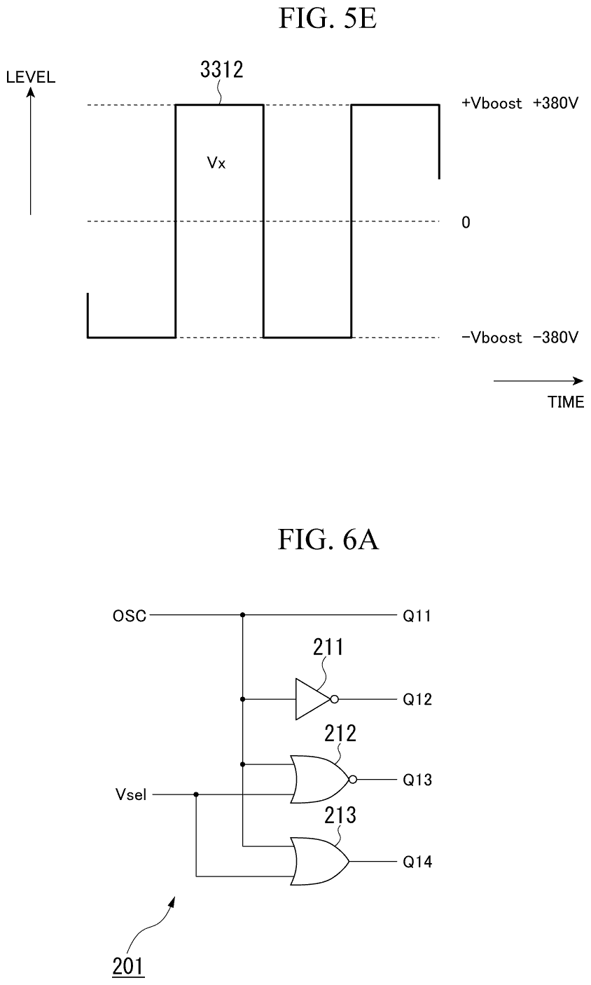

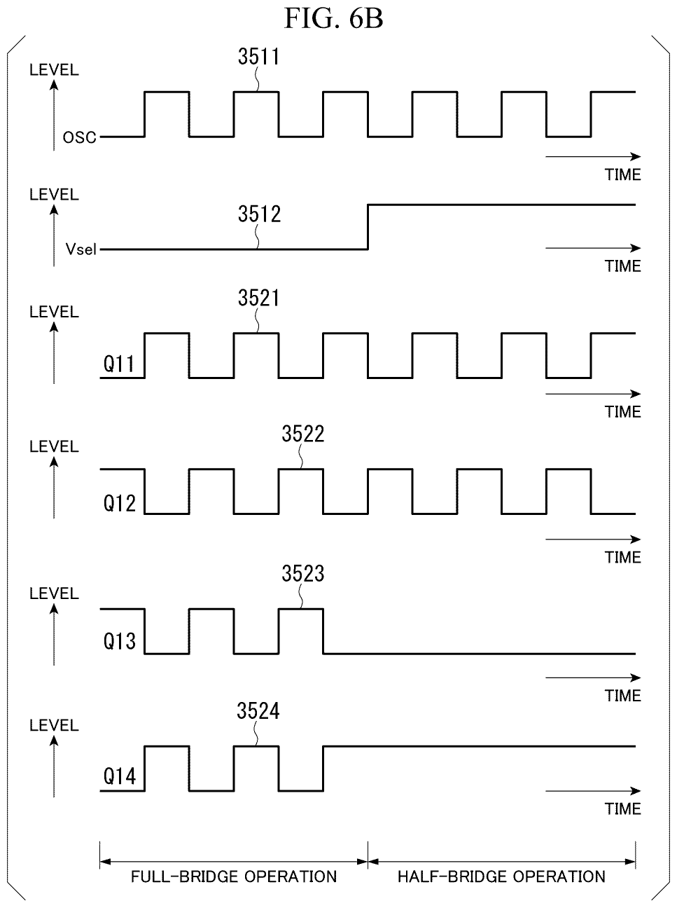

A drive signal switching circuit will be described with reference to FIGS. 6A and 6B.

FIG. 6A is a diagram showing an example of a drive signal switching circuit 201 according to the embodiment.

The drive signal switching circuit 201 switches the operating mode of the electric current resonant converter B2 between the full-bridge mode and the half-bridge mode.

In the present embodiment, the control circuit 111 (for example, the electric current resonant converter drive circuit 134) has a drive signal switching circuit 201.

The drive signal switching circuit 201 includes a NOT circuit 211, a NOR circuit 212, and an OR circuit 213.

Here, the control circuit 111 includes an oscillator (not shown) and an output from the oscillator will be described as an oscillator-specific output OSC.

Moreover, the control circuit 111 generates an input voltage determination signal Vsel indicating either the 200 VAC system or the 400 VAC system as an input voltage determination result.

In the present embodiment, the control circuit 111 designates the input voltage determination signal Vsel as a low-level signal when the input voltage detected by the input voltage detection circuit 151 is a low level and designates the input voltage determination signal Vsel as a high-level signal when the input voltage detected by the input voltage detection circuit 151 is a high level.

In the drive signal switching circuit 201, the oscillator-specific output OSC is a switch drive signal of the MOSFET Q11 (a control voltage applied to a gate thereof).

Moreover, the oscillator-specific output OSC is input to an input terminal of the NOT circuit 211 and an output from an output terminal of the NOT circuit 211 (a signal obtained by inverting the oscillator-specific output OSC) is a switch drive signal of the MOSFET Q12 (a control voltage applied to a gate thereof).

Moreover, the oscillator-specific output OSC and the input voltage determination signal Vsel are input to the two input terminals of the NOR circuit 212 and an output from the output terminal of the NOR circuit 212 is a switch drive signal of the MOSFET Q13 (a control voltage applied to a gate thereof).

Moreover, the oscillator-specific output OSC and the input voltage determination signal Vsel are input to the two input terminals of the OR circuit 213, and an output from the output terminal of the OR circuit 213 is a switch drive signal of the MOSFET Q14 (a control voltage applied to a gate thereof).

FIG. 6B is a diagram showing an example of an input/output signal of the drive signal switching circuit 201 according to the embodiment.

In the graph shown in FIG. 6B, the horizontal axis represents time and the vertical axis represents a level of a voltage of each signal.

As the input signal of the drive signal switching circuit 201, a signal 3511 corresponding to the oscillator-specific output OSC and a signal 3512 corresponding to the input voltage determination signal Vsel are shown.

Moreover, as the output signal of the drive signal switching circuit 201, a control voltage signal 3521 of the MOSFET Q11, a control voltage signal 3522 of the MOSFET Q12, a control voltage signal 3523 of the MOSFET Q13, and a control voltage signal 3524 of the MOSFET Q14 are shown.

With these signals, switching between the full-bridge operation and the half-bridge operation is implemented in the electric current resonant converter B2.

In addition, the circuits and signals shown in FIGS. 6A and 6B are examples, and any other configuration may be used as a configuration for switching between the full-bridge operation and the half-bridge operation in the electric current resonant converter B2.

### <Example of Timing of Switching of Operating Mode of Electric Current Resonant Converter>

In the present embodiment, a case where the output voltage fluctuates and an overcurrent and an overvoltage are generated in the element at the moment when a configuration of the primary side of the electric current resonant converter B2 is switched between the full-bridge configuration and the half-bridge configuration is conceivable.

Therefore, in the present embodiment, the bridge operation is not switched during the operation of the power conversion device 1. For example, in the power conversion device 1, a control process is performed so that the operating mode of the full-bridge operation is selected when the input voltage is less than a reference value (a threshold value) during activation and a control process is performed so that the operating mode of the half-bridge operation is selected when the input voltage is greater than the reference value (the threshold value) during activation. In the power conversion device 1, after this selection is performed, the selected operating mode is fixed even if the input voltage fluctuates.

In addition, in the power conversion device 1, when a reset operation is performed by blocking the input, a new operating mode is subsequently selected during activation. That is, in the power conversion device 1, when the reset operation is performed, the operating mode can be changed.

### <Example of Operation of Power Conversion Device>

An example of an operation of the power conversion device 1 according to the present embodiment will be described with reference to FIG. 1.

The boost converter B1 boosts the input voltage Vin input to the input terminal (the terminal connected to the AC power supply 11 in the present embodiment), designates a result of boosting the input voltage Vin as an output voltage (the voltage Vc1), and outputs the output voltage while charging the output capacitor (the capacitor 34) connected to the output terminal (the terminal connected to the electric current resonant converter B2 in the present embodiment).

Here, the boost converter B1 has an AC input configuration in the present embodiment, but the boost converter B1 may have a DC input configuration as another example.

Although a power factor correction (PFC) converter that performs power factor correction control (PFC control) is used as the boost converter B1 in the present embodiment, the PFC function may not necessarily be provided.

The output voltage detection circuit 152 detects the voltage of the output capacitor (the capacitor 34).

The boost converter control circuit 131 controls the boost converter B1 on the basis of the voltage detected by the output voltage detection circuit 152.

The input voltage detection circuit 151 detects a voltage corresponding to the input voltage (Vin) for the boost converter B1.

The operating mode setting circuit 133 sets the output voltage of the boost converter B1 to a low level (a low-level mode) or a high level (a high-level mode) in accordance with a value of the voltage detected by the input voltage detection circuit 151.

The control circuit 111 (the electric current resonant converter drive circuit 134) controls the electric current resonant converter B2 of the full bridge in accordance with the level (mode) set by the operating mode setting circuit 133.

Specifically, the control circuit 111 (the electric current resonant converter drive circuit 134) performs a control process so that an operation is performed in the full-bridge mode at the low level and performs a control process so that an operation is performed in the half-bridge mode at the high level.

In the present embodiment, the set level is decided at any timing after the input voltage is input and the operating mode of the electric current resonant converter is maintained until the set level is reset.

### <Example of Operation at Fixed Frequency of Electric Current Resonant Converter>

The electric current resonant converter B2 may be configured to operate at a fixed frequency.

Specifically, the switching elements (the MOSFETs Q11 to Q14) operating in the full-bridge mode or the half-bridge mode as the operating mode are configured to operate at a fixed frequency without an operation in a feedback control process for an output voltage output from the secondary circuit (a control process of feeding back a voltage on the secondary side of the transformer TR1).

The fixed frequency is, for example, a frequency near the resonant frequency (see, for example, FIG. 4B).

In the configuration in which the electric current resonant converter B2 operates at a fixed frequency, a control circuit for changing the frequency can be eliminated and the control circuit can be simplified.

Even if the frequency is variable, when the control point is uniform, the operation is similar to that at the fixed frequency.

Thereby, the electric current resonant converter B2 operates at 380 V when the input is at a low level (380 V) and operates at 760 V when the input is at a high level (760 V).

As described above, in the power conversion system A1 according to the present embodiment, the power conversion device 1 can achieve high efficiency even if the input voltage of the boost converter B1 can have two types of input voltage levels in the configuration in which the electric current resonant converter B2 is provided in a stage subsequent to the boost converter B1.

Here, a case where the secondary circuit of the electric current resonant converter B2 includes a rectification circuit using two diodes 91 and 92 has been described in the present embodiment, but other rectification circuits may be provided. Although a case where the resistor 12 is provided on the output side of the electric current resonant converter B2 has been exemplified in the present embodiment, any other circuit may be connected instead of the resistor 12.

### Second Embodiment

A second embodiment will be described.

### [Power Conversion System]

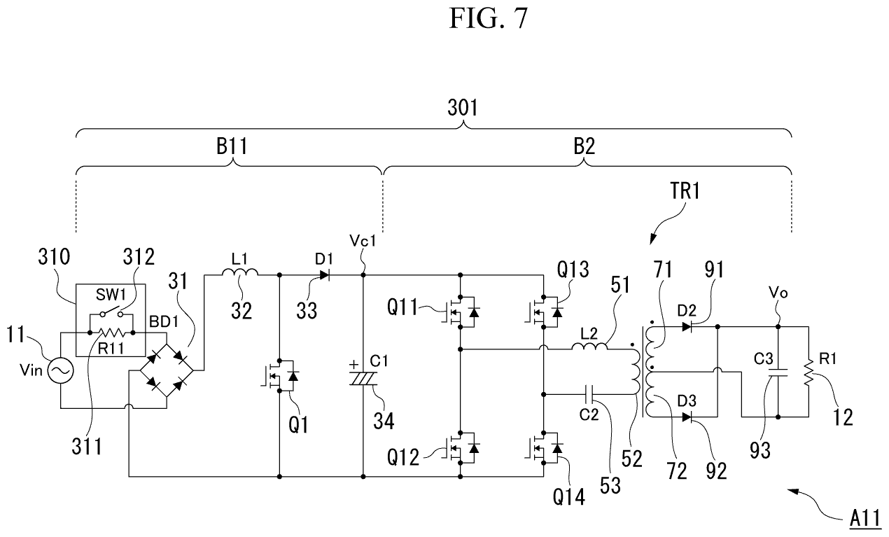

FIG. 7 is a diagram showing an example of a configuration of a circuit of a power conversion system A11 according to the second embodiment.

Here, in the present embodiment, for the convenience of description, constituent parts similar to those shown in FIG. 1 according to the first embodiment are denoted by the same reference signs and detailed description thereof will be omitted.

The power conversion system A11 according to the present embodiment includes a power conversion device 301, an AC power supply 11, and a resistor 12.

The power conversion device 301 includes a boost converter B11 and an electric current resonant converter B2.

In the example of FIG. 7, the illustration of the control circuit 111 shown in FIG. 1 is omitted.

The configuration and operation of the power conversion system A11 according to the present embodiment are schematically different from the configuration and operation of the power conversion system A1 shown in FIG. 1 according to the first embodiment in that the boost converter B11 includes an inrush current limit circuit 310.

The inrush current limit circuit 310 includes a resistor 311 and a switch 312.

The resistor 311 and the switch 312 are connected in parallel between one terminal of the AC power supply 11 and a diode bridge 31.

In the present embodiment, for convenience of description, the inrush current limit circuit 310 provided in a stage previous to the boost converter B11 is considered to be a circuit part of the boost converter B11. However, for example, the inrush current limit circuit 310 may be considered to be a circuit separate from the boost converter B11.

### <Example of Operation of Inrush Current Limit Circuit>

The boost converter B11 has an inrush current limit circuit 310 within a path along which an output capacitor (a capacitor 34) is charged.

The control circuit 111 (for example, the boost converter control circuit 131) is configured to control the switch 312 of the inrush current limit circuit 310 so that it is in an open (OFF) state during activation and suppress the inrush current when the inrush current passes through the resistor 311. Subsequently, at a predetermined timing when the inrush current is terminated, the control circuit 111 (for example, the boost converter control circuit 131) controls the switch 312 of the inrush current limit circuit 310 so that it is in a conductive (ON) state.

In the present embodiment, the control circuit 111 (for example, the boost converter control circuit 131) decides a target boost voltage of the boost converter B11 in accordance with a voltage detected by the input voltage detection circuit 151 after an inrush current during activation is terminated and an inrush current limit of the inrush current limit circuit 310 is canceled (or after the switch 312 is turned on). This decision process may be, for example, a process of selecting one target boost voltage from a plurality of target boost voltages (380 V or 760 V in the present embodiment).

Here, in the present embodiment, the activation time is the time of activation (startup) of the AC power supply 11.

### <Example of Boost Voltage Selection Process>

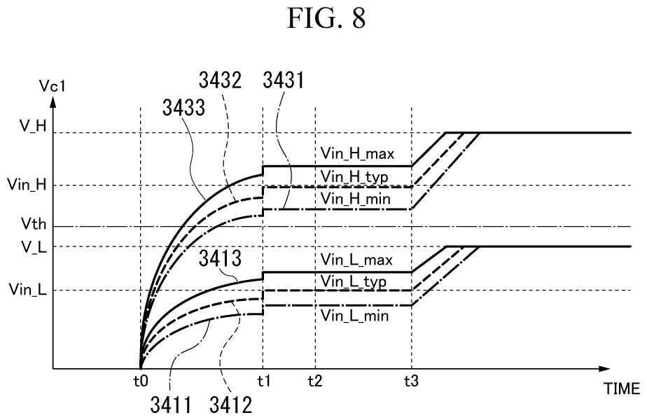

FIG. 8 is a diagram showing a processing flow representing an example of the boost voltage selection process according to the second embodiment.

The control circuit 111 performs a process of selecting a boost voltage on the basis of an input voltage detection result.

In the graph shown in FIG. 8, the horizontal axis represents time and the vertical axis represents a voltage Vc1 applied between both ends of the capacitor 34.

On the horizontal axis of the graph, times t0 to t3 are shown.

On the vertical axis of the graph, a low-level input voltage Vin_L, a low-level output voltage V_L, a threshold voltage Vth, a high-level input voltage Vin_H, and a high-level output voltage V_H are shown in relation to the boost converter B11.

Here, a range of the low-level input voltage Vin_L is expressed in a range of Vin_L_min to Vin_L_max. Moreover, the midpoint of the range is indicated by Vin_L_typ.

Moreover, a range of the high-level input voltage Vin_H is expressed in a range of Vin_H_min to Vin_H_max. In addition, the midpoint of the range is indicated by Vin_H_typ.

In the example of FIG. 8, a characteristic 3411 when the input voltage is Vin_L_min, a characteristic 3412 when the input voltage is Vin_L_typ, a characteristic 3413 when the input voltage is Vin_L_max, a characteristic 3431 when the input voltage is Vin_H_min, a characteristic 3432 when the input voltage is Vin_H_typ, and a characteristic 3433 when the input voltage is Vin_H_max are shown.

Moreover, the threshold voltage Vth is a level serving as a reference for switching the operating mode.

In the present embodiment, a setting process is performed so that (Vin_L_max<Vth<Vin_H_min).

At time t0, an input voltage is input to the power conversion device 301.

First, in the power conversion device 301, the switch 312 of the inrush current limit circuit 310 is open and the boost converter B11 charges the output capacitor (the capacitor 34) via the inrush current prevention resistor (the resistor 311).

Subsequently, at time t1, the power conversion device 301 causes the switch 312 parallel to the inrush current prevention resistor (the resistor 311) to be conductive (or causes a switch element to be turned on).

At this time, the voltage of the output capacitor (the capacitor 34) is further increased by a voltage difference between a voltage applied to the inrush current prevention resistor (the resistor 311) and a voltage applied when the switch 312 is in a conductive state.

Subsequently, at time t2, the power conversion device 301 detects and determines the input voltage.

That is, the power conversion device 301 performs a control process so that the target value of the boost voltage is set to the low-level output voltage V_L and the full-bridge operation is performed in the electric current resonant converter B2 when it is determined that the input voltage Vin (the voltage Vc1 applied between both ends of the capacitor 34 in the present embodiment) is lower than the threshold voltage Vth serving as the reference value.

On the other hand, the power conversion device 301 performs a control process so that the target value of the boost voltage is set to the high-level output voltage V_H and the half-bridge operation is performed in the electric current resonant converter B2 when it is determined that the input voltage Vin (the voltage Vc1 applied between both ends of the capacitor 34 in the present embodiment) is higher than the threshold voltage Vth serving as the reference value.

In addition, when a setting process is performed so that a case where the input voltage Vin (the voltage Vc1 applied between both ends of the capacitor 34 in the present embodiment) is set to be equal to the threshold voltage Vth serving as the reference value is eliminated, the setting process may be performed so that the operating mode is set to a predetermined operating mode (either the full-bridge mode or the half-bridge mode in the present embodiment) when there is such a case.

Subsequently, at time t3, the power conversion device 301 performs an output process so that the operation of the boost circuit (the boost converter B11) starts and the set target boost voltage value is reached and performs a control process so that an operation of the electric current resonant circuit (the electric current resonant converter B2) starts in accordance with the set target boost voltage value.

Thus, in the power conversion device 301 according to the present embodiment, the output capacitor (the capacitor 34) is charged during a period from time t0 to time t1, the voltage corresponding to the input voltage of the boost converter B11 is detected at time t2 after time t1 (the voltage Vc1 applied between both ends of the capacitor 34 in the present embodiment), and a switching process is performed between the systems (the 200 VAC system and the 400 VAC system) serving as an adaptation target at time t3.

As described above, in the power conversion system A11 according to the present embodiment, the power conversion device 301 can achieve high efficiency even if an input voltage of the boost converter B11 can have two types of input voltage levels in a configuration in which the electric current resonant converter B12 is provided in a stage subsequent to the boost converter B11.

### Third Embodiment

A third embodiment will be described.

### [Power Conversion System]

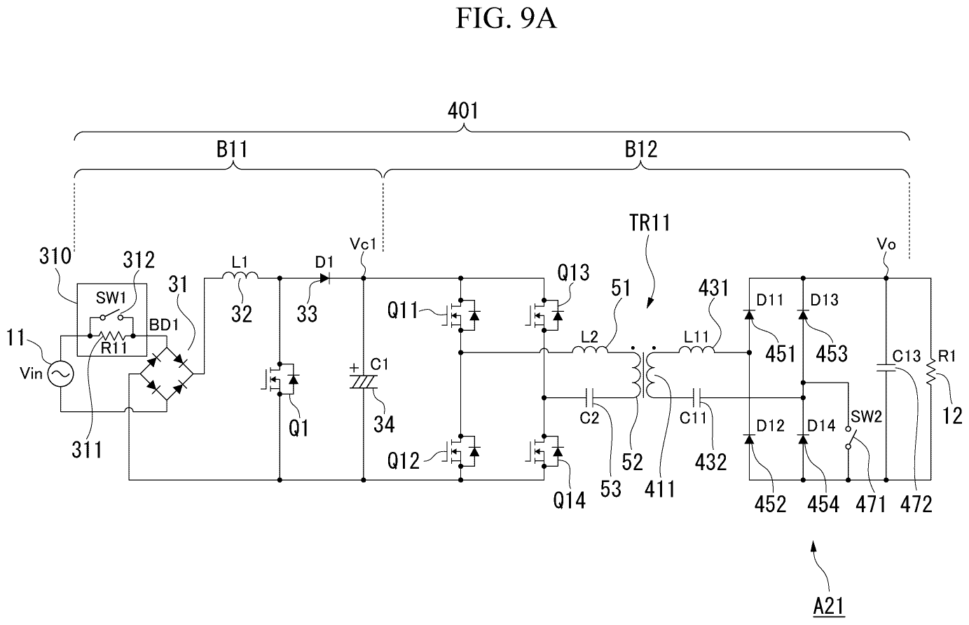

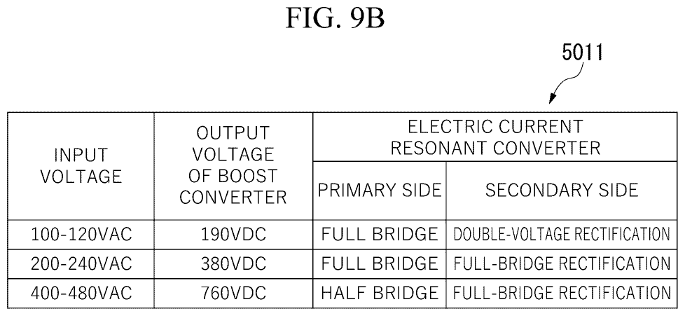

FIG. 9A is a diagram showing an example of a configuration of a circuit of a power conversion system A21 according to the third embodiment.

Here, in the present embodiment, for the convenience of description, constituent parts similar to those shown in FIG. 7 according to the second embodiment are denoted by the same reference signs and detailed description thereof will be omitted.

The power conversion system A21 according to the present embodiment includes a power conversion device 401, an AC power supply 11, and a resistor 12.

The power conversion device 401 includes a boost converter B11 and an electric current resonant converter B12.

In the example of FIG. 9A, the illustration of the control circuit 111 shown in FIG. 1 is omitted.

The configuration and operation of the power conversion system A21 according to the present embodiment are schematically different from the configuration and operation of the power conversion system A11 shown in FIG. 7 according to the second embodiment in that an operating mode is switched among three operating modes and a configuration and operation of a secondary side of the electric current resonant converter B12 are different.

On the secondary side, the electric current resonant converter B12 includes a secondary winding 411, an inductor 431, a capacitor 432, four diodes 451 to 454 which are rectification elements, a switch 471, and a capacitor 472.

Here, the switch 471 may be configured using, for example, a semiconductor switch element or may be configured using a mechanical switch (for example, a relay or the like).

Moreover, a transformer TR11 includes a primary winding 52 and a secondary winding 411.

Moreover, in the present embodiment, a full-bridge rectification circuit is provided.

### <Circuit Connection Relationship>

A connection relationship of the secondary circuit of the electric current resonant converter B12 will be described.

One end of the secondary winding 411 and one end of the inductor 431 are connected.

The other end of the secondary winding 411 and one end of the capacitor 432 are connected.

The other end of the inductor 431, an anode of the diode 451, and a cathode of the diode 452 are connected.

The other end of the capacitor 432, an anode of the diode 453, a cathode of the diode 454, and one end of the switch 471 are connected.

A cathode of the diode 451, a cathode of the diode 453, one end of the capacitor 472, and one end of the resistor 12 are connected.

An anode of the diode 452, an anode of the diode 454, the other end of the switch 471, the other end of the capacitor 472, and the other end of the resistor 12 are connected.

Thus, in the secondary circuit of the electric current resonant converter B12, the rectification circuit includes a leg in which the diode 451 and the diode 452 are connected in series and a leg in which the diode 453 and the diode 454 are connected in series.

These two legs are connected in parallel.

Both ends of the secondary winding 411 are connected to two connection points, i.e., a connection point between the diode 451 and the diode 452 and a connection point between the diode 453 and the diode 454, via the inductor 431 and the capacitor 432.

The control circuit 111 controls the ON/OFF switching of the switch 471.

The control circuit 111 can switch the rectification circuit to a double-voltage rectification circuit by short-circuiting any one diode (the diode 454 in the present embodiment) of the four diodes 451 to 454 with the switch 471 (i.e., by turning on the switch 471).

### <Example of Capacitor-Inductor-Inductor Capacitor (CLLC) Type Resonant Circuit>

In the example of FIG. 9A, the electric current resonant converter B12 is of a CLLC type.

The CLLC type resonant circuit in the electric current resonant converter B12 includes a capacitor 53 and an inductor 51 of the primary circuit and an inductor 431 and a capacitor 432 of the secondary circuit.

Thus, an input terminal of the rectification circuit and both ends of the secondary winding 411 are connected via a resonant inductor (the inductor 431) and a resonant capacitor (the capacitor 432).

<Example in which Leakage Inductance is Used>

For example, one or both of the resonant inductor (the inductor 51) of the primary circuit of the transformer TR11 and the resonant inductor (the inductor 431) of the secondary circuit of the transformer TR11 may have the leakage inductance of the transformer TR11.

### <Example of Operation>

FIG. 9B is a diagram showing a table 5011 showing an example of a relationship of an input voltage, an output voltage of the boost converter B11, and an operating mode of the electric current resonant converter B12 according to the third embodiment.

In the present embodiment, the operating mode can be switched among three operating modes. In the present embodiment, the operating mode setting circuit 133 sets the operating mode to one of the three operating modes.

In the present embodiment, a case where there are three operating modes, i.e., an operating mode corresponding to a 100 VAC system, an operating mode corresponding to a 200 VAC system, and an operating mode corresponding to a 400 VAC system, is shown.

In the present embodiment, when the input voltage for the power conversion device 401 (the boost converter B11) is 100 to 120 VAC (the 100 VAC system), the output voltage of the boost converter B11 is 190 VDC, the primary side of the electric current resonant converter B12 is controlled so that the full-bridge operation is performed, and the secondary side of the electric current resonant converter B12 is controlled so that a double-voltage rectification operation is performed.

Moreover, in the present embodiment, when the input voltage for the power conversion device 401 (the boost converter B11) is 200 to 240 VAC (the 200 VAC system), the output voltage of the boost converter B11 is 380 VDC, the primary side of the electric current resonant converter B12 is controlled so that the full-bridge operation is performed and the secondary side of the electric current resonant converter B12 is controlled so that the full-bridge rectification operation is performed.

Moreover, in the present embodiment, when the input voltage for the power conversion device 401 (the boost converter B11) is 400 to 480 VAC (the 400 VAC system), the output voltage of the boost converter B11 is 760 VDC, the primary side of the electric current resonant converter B12 is controlled so that the half-bridge operation is performed and the secondary side of the electric current resonant converter B12 is controlled so that the full-bridge rectification operation is performed.

Thus, in the power conversion device 401 according to the present embodiment, when the voltage detected by the input voltage detection circuit 151 (the voltage corresponding to the input voltage during activation) is lower than a prescribed voltage Vth1, the primary side of the electric current resonant converter B12 is controlled in the full-bridge mode and the secondary rectification circuit operates as a double-voltage rectification circuit by performing a short-circuiting process with the switch 471.

Moreover, in the power conversion device 401 according to the present embodiment, when the voltage detected by the input voltage detection circuit 151 (the voltage corresponding to the input voltage during activation) is higher than the prescribed voltage Vth1 and lower than a prescribed voltage Vth2, the primary side of the electric current resonant converter B12 is controlled in the full-bridge mode and the secondary rectification circuit operates as a full-bridge rectification circuit without performing a short-circuiting process with the switch 471.

Moreover, in the power conversion device 401 according to the present embodiment, when the voltage detected by the input voltage detection circuit 151 (the voltage corresponding to the input voltage during activation) is higher than the prescribed voltage Vth2, the primary side of the electric current resonant converter B12 is controlled in the half-bridge mode and the secondary rectification circuit operates as a full-bridge rectification circuit without performing a short-circuiting process with the switch 471.

In addition, when the voltage detected by the input voltage detection circuit 151 (the voltage corresponding to the input voltage during activation) is equal to the prescribed voltage Vth1, for example, a configuration in which a control process similar to that when the voltage is lower than the prescribed voltage Vth1 is performed may be adopted or a configuration in which a control process similar to that when the voltage is higher than the prescribed voltage Vth1 is performed may be adopted.

Moreover, when the voltage detected by the input voltage detection circuit 151 (the voltage corresponding to the input voltage during activation) is equal to the prescribed voltage Vth2, for example, a configuration in which a control process similar to that when the voltage is lower than the prescribed voltage Vth2 is performed may be adopted or a configuration in which a control process similar to that when the voltage is higher than the prescribed voltage Vth2 is performed may be adopted.

As described above, in the power conversion system A21 according to the present embodiment, the power conversion device 401 can achieve high efficiency even if an input voltage of the boost converter B11 can have two or more types of input voltage levels in a configuration in which the electric current resonant converter B12 is provided in a stage subsequent to the boost converter B11.

### Fourth Embodiment

A fourth embodiment will be described.

### [Power Conversion System]

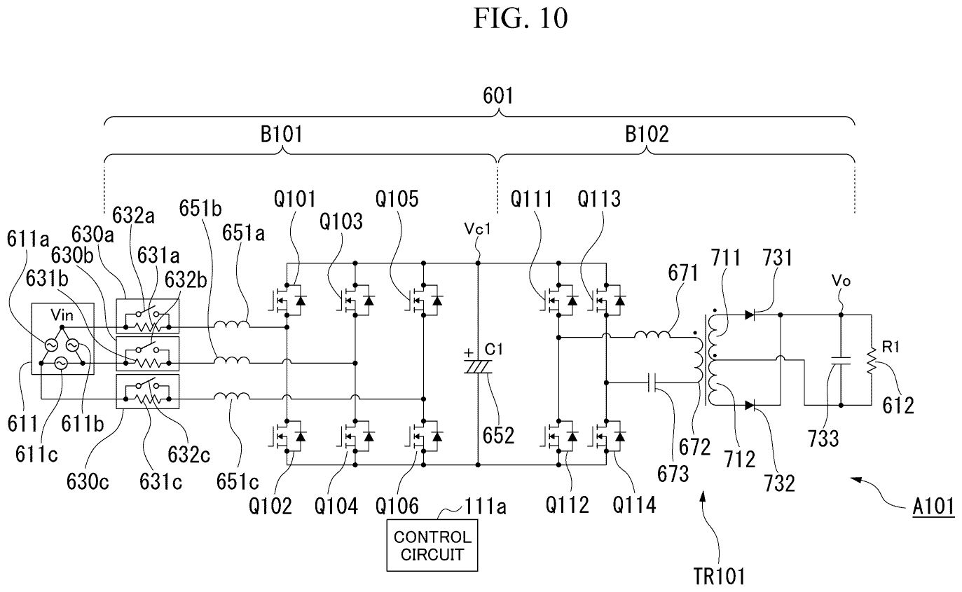

FIG. 10 is a diagram showing an example of a configuration of a circuit of a power conversion system A101 according to the fourth embodiment.

The power conversion system A101 includes a power conversion device 601, a three-phase AC power supply unit 611, and a resistor 612.

The power conversion device 601 includes a boost converter B101, an electric current resonant converter B102, and a control circuit 111a.

The electric current resonant converter B102 is connected to a stage subsequent to the boost converter B101.

In the present embodiment, a case where the input voltage of the boost converter B101 is a three-phase AC is shown.

Here, the configuration and operation of the power conversion system A101 according to the present embodiment are schematically different from the configuration and operation of the power conversion system A11 according to the second embodiment in that a three-phase AC is input to the power conversion device 601, but they are similar in terms of others.

The control circuit 111a, for example, includes a function similar to that of the control circuit 111 shown in FIG. 1. For this reason, in the present embodiment, the illustration and detailed description of the control circuit 111a will be omitted with respect to a function similar to that of the control circuit 111 shown in FIG. 1.

Although a case where the AC power supply unit 611 and the resistor 612 are circuit elements outside of the power conversion device 601 is shown in the present embodiment, a configuration in which one or both of the AC power supply unit 611 and the resistor 612 are circuit elements inside of the power conversion device 601 may be used as another example.

For example, when both the AC power supply unit 611 and the resistor 612 are circuit elements inside of the power conversion device 601, the power conversion system A101 and the power conversion device 601 according to the present embodiment are equivalent.

The AC power supply unit 611 is a power supply that outputs a three-phase AC power, and is configured by combining three single-phase AC power supplies 611a, 611b, and 611c.

The boost converter B101 includes three inrush current limit circuits 630a, 630b, and 630c and three inductors 651a, 651b, and 651c in correspondence with three phases.

Moreover, the boost converter B101 includes six MOSFETs Q101 to Q106 and a capacitor 652.

The inrush current limit circuit 630a includes a resistor 631a and a switch 632a connected in parallel.

The inrush current limit circuit 630b includes a resistor 631b and a switch 632b connected in parallel.

The inrush current limit circuit 630c includes a resistor 631c and a switch 632c connected in parallel.

Although the inrush current limit circuits 630a to 630c provided in a stage previous to the boost converter B101 are considered to be a circuit unit of the boost converter B101 for convenience of description in the present embodiment, for example, the inrush current limit circuits 630a to 630c may be considered to be circuits separate from the boost converter B101.

A first phase terminal of the AC power supply unit 611 is connected to a source of the MOSFET Q101 and a drain of the MOSFET Q102 via the inrush current limit circuit 630a and the inductor 651a.

A second phase terminal of the AC power supply unit 611 is connected to a source of the MOSFET Q103 and a drain of the MOSFET Q104 via the inrush current limit circuit 630b and the inductor 651b.

A third phase terminal of the AC power supply unit 611 is connected to a source of the MOSFET Q105 and a drain of the MOSFET Q106 via the inrush current limit circuit 630c and the inductor 651c.

A drain of the MOSFET Q101, a drain of the MOSFET Q103, a drain of the MOSFET Q105, and one end of the capacitor 652 are connected.

A source of the MOSFET Q102, a source of the MOSFET Q104, a source of the MOSFET Q106, and the other end of the capacitor 652 are connected.

The electric current resonant converter B102 includes four MOSFETs Q111 to Q114, an inductor 671, a primary winding 672, a capacitor 673, secondary windings 711 and 712, two diodes 731 and 732, and a capacitor 733.

Here, a transformer TR101 includes the primary winding 672 and the secondary windings 711 and 712.

In the present embodiment, the secondary windings 711 and 712 are divided into two parts with respect to the point of the center tap according to a center tap method and are referred to as the secondary winding 711 and the secondary winding 712 for convenience of description. The secondary winding 711 and the secondary winding 712 may be integrated.

The internal circuit configuration of the electric current resonant converter B102 is similar to the internal circuit configuration of the electric current resonant converter B2 shown in FIG. 7.

Moreover, a connection relationship in which the electric current resonant converter B102 is connected between the capacitor 652 and the resistor 612 of the boost converter B101 is similar to a connection relationship in which the electric current resonant converter B2 is connected between the capacitor 34 and the resistor 12 of the boost converter B11 shown in FIG. 7.

The control circuit 111a detects an output voltage (a voltage applied between both ends of the capacitor 652) with respect to the boost converter B101 and controls a control voltage to be applied to gates of six MOSFETs Q101 to Q106 in correspondence with the three-phase AC on the basis of the detected voltage.

Moreover, the control circuit 111a controls the switches 632a, 632b, and 632c of the three inrush current limit circuits 630a, 630b, and 630c.

The control circuit 111a detects the voltage corresponding to the input voltage, and sets the operating mode (the full-bridge mode or the half-bridge mode) of the electric current resonant converter B102 on the basis of the detected voltage.

Also, the control circuit 111a controls the control voltage applied to the gates of the MOSFETs Q111 to Q114 of the electric current resonant converter B102 in accordance with the set operating mode.

As described above, in the power conversion system A101 according to the present embodiment, the power conversion device 601 can achieve high efficiency even if an input voltage of the boost converter B101 can have two types of input voltage levels in a configuration in which the electric current resonant converter B102 is provided in a stage subsequent to the boost converter B101.

### Fifth Embodiment

A fifth embodiment will be described.

### [Power Conversion System]

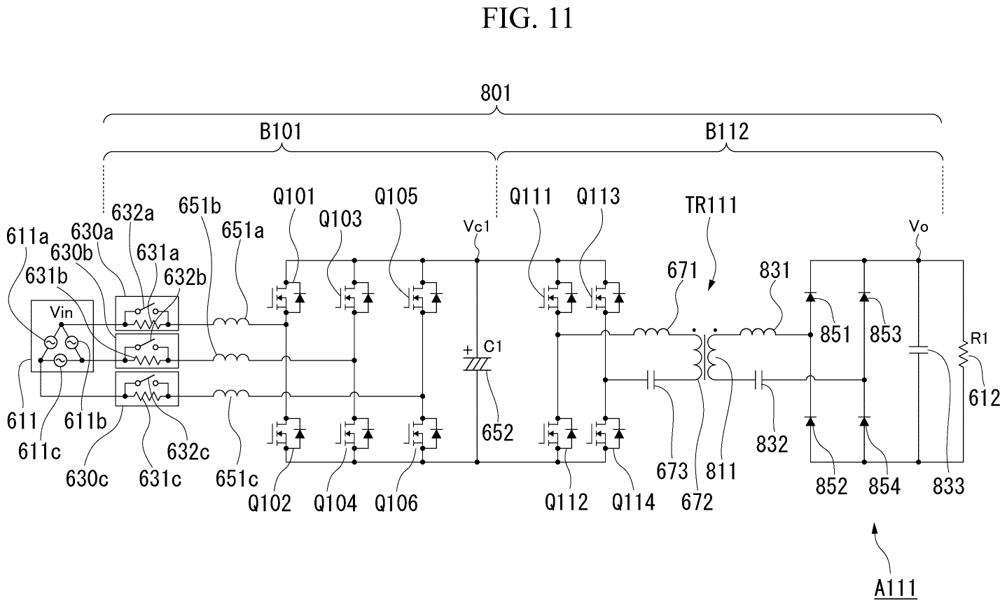

FIG. 11 is a diagram showing an example of a configuration of a circuit of a power conversion system A111 according to the fifth embodiment.

Here, in the present embodiment, for the convenience of description, constituent parts similar to those shown in FIG. 10 according to the fourth embodiment are denoted by the same reference signs and detailed description thereof will be omitted.

The power conversion system A111 according to the present embodiment includes a power conversion device 801, an AC power supply unit 611, and a resistor 612.

The power conversion device 801 includes a boost converter B101 and an electric current resonant converter B112.

In the example of FIG. 11, the illustration of the control circuit 111a shown in FIG. 10 is omitted.

The configuration and operation of the power conversion system A111 according to the present embodiment are schematically different from the configuration and operation of the power conversion system A101 shown in FIG. 10 according to the fourth embodiment in that the configuration and operation of the secondary side of the electric current resonant converter B112 are different.

The electric current resonant converter B112 includes a secondary winding 811, an inductor 831, a capacitor 832, four diodes 851 to 854 that are rectification elements, and a capacitor 833 on the secondary side.

Here, a transformer TR111 includes a primary winding 672 and a secondary winding 811.

Moreover, in the present embodiment, a full-bridge rectification circuit is provided.

### <Circuit Connection Relationship>

A connection relationship of the secondary circuit of the electric current resonant converter B112 will be described.

One end of the secondary winding 811 and one end of the inductor 831 are connected.

The other end of the secondary winding 811 and one end of the capacitor 832 are connected.

The other end of the inductor 831, an anode of the diode 851, and a cathode of the diode 852 are connected.

The other end of the capacitor 832, an anode of the diode 853, and a cathode of the diode 854 are connected.

A cathode of the diode 851, a cathode of the diode 853, one end of the capacitor 833, and one end of the resistor 612 are connected.

An anode of the diode 852, an anode of the diode 854, the other end of the capacitor 833, and the other end of the resistor 612 are connected.

Thus, in the secondary circuit of the electric current resonant converter B112, the rectification circuit includes a leg in which the diode 851 and the diode 852 are connected in series and a leg in which the diode 853 and the diode 854 are connected in series.

These two legs are connected in parallel.

Both ends of the secondary winding 811 are connected to two connection points, i.e., a connection point between the diode 851 and the diode 852 and a connection point between the diode 853 and the diode 854, via the inductor 831 and the capacitor 832.

### <Example of CLLC Type Resonant Circuit>

In the example of FIG. 11, the electric current resonant converter B112 is of a CLLC type.

The CLLC type resonant circuit in the electric current resonant converter B112 includes a capacitor 673 and an inductor 671 in the primary circuit and the inductor 831 and the capacitor 832 in the secondary circuit.

Thus, the input terminal of the rectification circuit and both ends of the secondary winding 811 are connected via a resonant inductor (the inductor 831) and a resonant capacitor (the capacitor 832).

<Example in which Leakage Inductance is Used>

For example, one or both of the resonant inductor (the inductor 671) of the primary circuit of the transformer TR111 and the resonant inductor (the inductor 831) of the secondary circuit of the transformer TR111 may have the leakage inductance of the transformer TR111.

As described above, in the power conversion system A111 according to the present embodiment, the power conversion device 801 can achieve high efficiency even if an input voltage of the boost converter B101 can have two types of input voltage levels in a configuration in which the electric current resonant converter B112 is provided in a stage subsequent to the boost converter B101.

### Sixth Embodiment

A sixth embodiment will be described.

### [Power Conversion System]

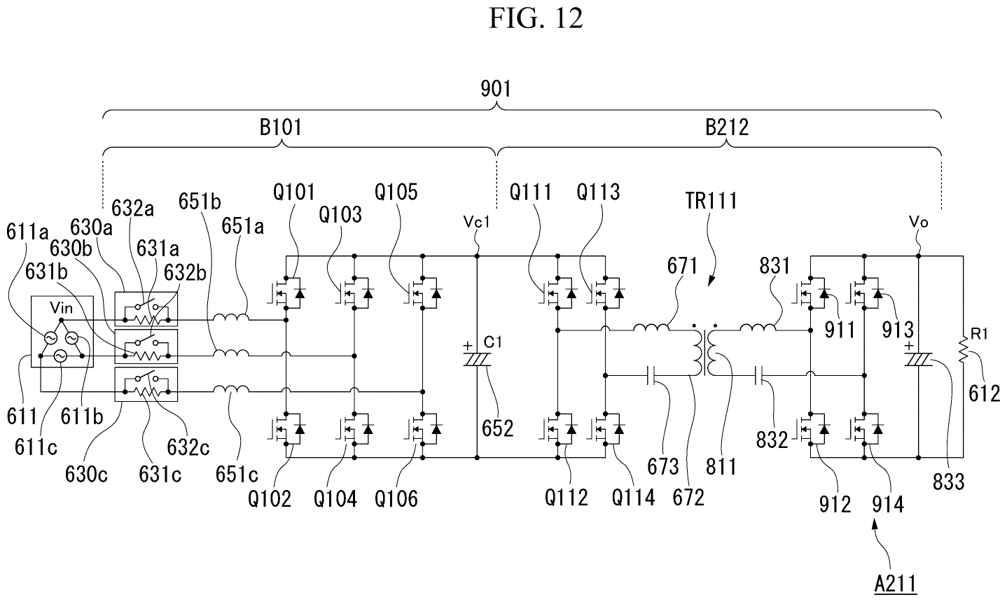

FIG. 12 is a diagram showing an example of a configuration of a circuit of a power conversion system A211 according to the sixth embodiment.

Here, in the present embodiment, for the convenience of description, constituent parts similar to those shown in FIG. 11 according to the fifth embodiment are denoted by the same reference signs and detailed description thereof will be omitted.

The power conversion system A211 according to the present embodiment includes a power conversion device 901, an AC power supply unit 611, and a resistor 612.

The power conversion device 901 includes a boost converter B101 and an electric current resonant converter B212.

In the example of FIG. 12, the illustration of the control circuit 111a shown in FIG. 10 is omitted.

The configuration and operation of the power conversion system A211 according to the present embodiment are schematically different from the configuration and operation of the power conversion system A111 shown in FIG. 11 according to the fifth embodiment in that the configuration and operation of the secondary side of the electric current resonant converter B212 are different.

The power conversion system A211 according to the present embodiment schematically includes four MOSFETs 911 to 914 instead of the four diodes 851 to 854 in the power conversion system A111 shown in FIG. 11 according to the fifth embodiment.

A rectification circuit includes these four MOSFETs 911 to 914.

In the present embodiment, the control circuit 111a has a function of controlling a control voltage to be applied to gates of these four MOSFETs 911 to 914.

As described above, in the power conversion system A211 according to the present embodiment, the power conversion device 901 can achieve high efficiency even if an input voltage of the boost converter B101 can have two types of input voltage levels in a configuration in which the electric current resonant converter B212 is provided in a stage subsequent to the boost converter B101.

### Regarding Above Embodiments

Also, a program for implementing the function of any constituent part of any device described above may be recorded on a computer-readable recording medium and the program may be read and executed by a computer system. Also, the “computer system” used here may include an operating system (OS) or hardware such as peripheral devices. Also, the “computer-readable recording medium” refers to a flexible disk, a magneto-optical disc, a read-only memory (ROM), a portable medium such as a compact disc-ROM (CD-ROM), or a storage device such as a hard disk embedded in the computer system. Furthermore, the “computer-readable recording medium” is assumed to include a medium that holds a program for a certain period of time, such as a volatile memory inside a computer system serving as a server or a client when the program is transmitted via a network such as the Internet or a communication circuit such as a telephone circuit. For example, the volatile memory may be a random-access memory (RAM). For example, the recording medium may be a non-transitory recording medium.

Moreover, the above-described program may be transmitted from a computer system storing the program in a storage device or the like to another computer system via a transmission medium or by transmission waves in a transmission medium. Here, the “transmission medium” for transmitting the program refers to a medium having a function of transmitting information, as in a network such as the Internet or a communication circuit such as a telephone circuit.

Moreover, the above-described program may be a program for implementing some of the above-described functions. Furthermore, the above-described program may be a so-called differential file capable of implementing the above-described function in combination with a program already recorded on the computer system. The differential file may be referred to as a differential program.

Moreover, the function of any constituent part of any device described above may be implemented by a processor. For example, each process in the embodiment may be implemented by a processor that operates on the basis of information of a program or the like and a computer-readable recording medium that stores information of a program or the like. Here, in the processor, for example, the function of each part may be implemented by individual hardware or the function of each part may be implemented by integrated hardware. For example, the processor may include hardware and the hardware may include at least one of a circuit that processes a digital signal and a circuit that processes an analog signal. For example, the processor may be configured using one or more circuit devices or/and one or more circuit elements mounted on a circuit board. An integrated circuit (IC) or the like may be used as the circuit device and a resistor, a capacitor, or the like may be used as the circuit element.

Here, the processor may be, for example, a CPU. However, the processor is not limited to the CPU and, for example, various types of processors such as a graphics processing unit (GPU) or a digital signal processor (DSP) may be used. Moreover, for example, the processor may be a hardware circuit based on an application-specific integrated circuit (ASIC). Moreover, the processor may include, for example, a plurality of CPUs, or may include a hardware circuit of a plurality of ASICs. Moreover, the processor may include, for example, a combination of a plurality of CPUs and a hardware circuit including a plurality of ASICs. Moreover, the processor may include, for example, one or more of an amplifier circuit and a filter circuit for processing an analog signal and the like.

Although embodiments of the present disclosure have been described in detail above with reference to the drawings, specific configurations are not limited to the embodiments and other designs and the like may also be included without departing from the scope of the present disclosure.

### Appendixes

Hereinafter, (Configuration Examples 1 to 8) are shown.

### Configuration Example 1

A power conversion device comprising:
a boost converter;
an electric current resonant converter connected to a stage subsequent to the boost converter; and
a control circuit,
wherein the boost converter boosts an input voltage to designate the boosted input voltage as an output voltage and output the output voltage while charging a first output capacitor with the output voltage,
wherein the control circuit controls the boost converter on the basis of a voltage detected by an output voltage detection circuit configured to detect a voltage of the first output capacitor,
wherein the control circuit sets the output voltage of the boost converter to a first output voltage level or a second output voltage level in accordance with a voltage detected by an input voltage detection circuit configured to detect a voltage corresponding to the input voltage, causes the electric current resonant converter to operate in a full-bridge mode as an operating mode when the first output voltage level has been set, and causes the electric current resonant converter to operate in a half-bridge mode as an operating mode when the second output voltage level has been set,
wherein the output voltage detection circuit and the input voltage detection circuit are a common circuit or separate circuits, and
wherein the first output voltage level or the second output voltage level is set at a predetermined timing after the input voltage is input and a set operating mode is maintained until a process of setting the first output voltage level or the second output voltage level is reset.

Here, in the power conversion device 1 according to the example of FIG. 1, the boost converter B1, the electric current resonant converter B2, the control circuit 111, the capacitor 34, the output voltage detection circuit 152, and the input voltage detection circuit 151 are an example of the boost converter, an example of the electric current resonant converter, an example of the control circuit, an example of the first output capacitor, an example of the output voltage detection circuit, and an example of the input voltage detection circuit, respectively.

Moreover, in the power conversion device 1 according to the example of FIG. 1, 380 V and 760 V are used as examples of the first output voltage level and the second output voltage level.

In the power conversion device 301 according to the example of FIG. 7, the boost converter B11 is an example of the boost converter.

In the power conversion device 401 according to the example of FIG. 9A, the electric current resonant converter B12 is an example of the electric current resonant converter.

In the power conversion device 601 according to the example of FIG. 10, the boost converter B101, the electric current resonant converter B102, the control circuit 111a, and the capacitor 652 are an example of the boost converter, an example of the electric current resonant converter, an example of the control circuit, and an example of a first output capacitor, respectively. In addition, in the example of FIG. 10, the control circuit 111a has a function similar to that of the output voltage detection circuit 152 and a function similar to that of the input voltage detection circuit 151.

In the power conversion device 801 according to the example of FIG. 11, the electric current resonant converter B112 is an example of the electric current resonant converter.

In the power conversion device 901 according to the example of FIG. 12, the electric current resonant converter B212 is an example of the electric current resonant converter.

### Configuration Example 2

The power conversion device according to [Configuration Example 1],
wherein the electric current resonant converter includes
a first leg in which a first switching element and a second switching element are connected in series;
a second leg in which a third switching element and a fourth switching element are connected in series;
a transformer having a primary winding and a secondary winding;
a first resonant inductor;
a first resonant capacitor; and
a first rectification circuit,
wherein, in a primary circuit of the transformer, the first leg and the second leg are connected in parallel and both ends of the primary winding are connected to two connection points, i.e., a connection point between the first switching element and the second switching element and a connection point between the third switching element and the fourth switching element, via the first resonant inductor and the first resonant capacitor,
wherein, in a secondary circuit of the transformer, both ends of the secondary winding are connected to an input end of the first rectification circuit, and
wherein, in the set operating mode, the first switching element, the second switching element, the third switching element, and the fourth switching element operate at a fixed frequency without a control process of feeding back an output from the secondary circuit.

Here, in the power conversion devices 1, 301, and 401 according to the examples of FIGS. 1, 7, and 9A, the MOSFETs Q11 to Q14 are examples of the first to fourth switching elements, the inductor 51 is an example of the first resonant inductor, and the capacitor 53 is an example of the first resonant capacitor.

In the power conversion devices 1 and 301 according to the examples of FIGS. 1 and 7, the transformer TR1 is an example of the transformer, the primary winding 52 is an example of the primary winding, the secondary windings 71 and 72 are examples of the secondary winding, and the rectification circuit including the diodes 91 and 92 is an example of the first rectification circuit.

In the power conversion device 401 according to the example of FIG. 9A, the transformer TR11 is an example of the transformer, the primary winding 52 is an example of the primary winding, the secondary winding 411 is an example of the secondary winding, and the rectification circuit including the diodes 451 to 454 is an example of the first rectification circuit.

In the power conversion devices 601, 801, and 901 according to the examples of FIGS. 10, 11, and 12, the MOSFETs Q111 to Q114 are examples of the first to fourth switching elements, the inductor 671 is an example of the first resonant inductor, and the capacitor 673 is an example of the first resonant capacitor.

In the power conversion device 601 according to the example of FIG. 10, the transformer TR101 is an example of the transformer, the primary winding 672 is an example of the primary winding, the secondary windings 711 and 712 are examples of the secondary winding, and the rectification circuit including the diodes 731 and 732 is an example of the first rectification circuit.

In the power conversion device 801 according to the example of FIG. 11, the transformer TR111 is an example of the transformer, the primary winding 672 is an example of the primary winding, the secondary winding 811 is an example of the secondary winding, and the rectification circuit including the diodes 851 to 854 is an example of the first rectification circuit.

In the power conversion device 901 according to the example of FIG. 12, the transformer TR111 is an example of a transformer, the primary winding 672 is an example of the primary winding, the secondary winding 811 is an example of the secondary winding, and the rectification circuit including the MOSFETs 911 to 914 is an example of the first rectification circuit.

### Configuration Example 3

The power conversion device according to [Configuration Example 2],
wherein the first rectification circuit is a full-bridge rectification circuit, and
wherein, in the secondary circuit, the input end of the first rectification circuit and both ends of the secondary winding are connected via a second resonant inductor and a second resonant capacitor.

Here, in the power conversion device 401 according to the example of FIG. 9A, the inductor 431 is an example of the second resonant inductor and the capacitor 432 is an example of the second resonant capacitor.

In the power conversion devices 801 and 901 according to the examples of FIGS. 11 and 12, the inductor 831 is an example of the first resonant inductor and the capacitor 832 is an example of the first resonant capacitor.

### Configuration Example 4

The power conversion device according to [Configuration Example 3], wherein leakage inductance of the transformer is used as the first resonant inductor and the second resonant inductor.

### Configuration Example 5

The power conversion device according to any one of [Configuration Examples 1 to 4],
wherein an inrush current limit circuit is provided within a path along which the first output capacitor is charged, and
wherein the control circuit decides a target boost voltage of the boost converter in accordance with a voltage detected by the input voltage detection circuit after an inrush current during activation is terminated and an inrush current limit of the inrush current limit circuit is canceled.

Here, in the power conversion devices 301 and 401 according to the examples of FIGS. 7 and 9A, the inrush current limit circuit 310 is an example of the inrush current limit circuit.

In the power conversion devices 601, 801, and 901 according to the examples of FIGS. 10, 11, and 12, the three-phase inrush current limit circuits 630a to 630c are examples of the inrush current limit circuit.

### Configuration Example 6

The power conversion device according to any one of [Configuration Examples 1 to 5],
wherein the input voltage is a single- or three-phase AC voltage, and
wherein the boost converter is a PFC converter configured to perform power factor improvement control.

Here, in the power conversion devices 1, 301, and 401 according to the examples of FIGS. 1, 7, and 9A, the input voltage is a single-phase AC voltage.

In the power conversion devices 601, 801, and 901 according to the examples of FIGS. 10, 11, and 12, the input voltage is a three-phase AC voltage.

### Configuration Example 7

The power conversion device according to [Configuration Example 3 or 4],
wherein the first rectification circuit includes
a third leg in which a first rectification element and a second rectification element are connected in series; and
a fourth leg in which a third rectification element and a fourth rectification element are connected in series,
wherein the third leg and the fourth leg are connected in parallel and both ends of the secondary winding are connected to two connection points, i.e., a connection point between the first rectification element and the second rectification element and a connection point between the third rectification element and the fourth rectification element,
wherein the first rectification circuit is operable as a double-voltage rectification circuit by short-circuiting any one target rectification element of the first rectification element, the second rectification element, the third rectification element, and the fourth rectification element with a first switch, and
wherein the first switch is a semiconductor switch element or relay.

In the power conversion device 401 according to the example of FIG. 9A, the diodes 451 to 454 are examples of the first to fourth rectification elements and the switch 471 is an example of the first switch.

In the example of FIG. 9A, the diode 454 (the fourth switch element) is a target rectification element serving as a short-circuiting target.

### Configuration Example 8

The power conversion device according to [Configuration Example 7],
wherein the control circuit causes the electric current resonant converter to operate in the full-bridge mode as the operating mode when a voltage detected by the input voltage detection circuit is lower than a first prescribed voltage and causes the first rectification circuit to operate as the double-voltage rectification circuit by short-circuiting the target rectification element with the first switch,
wherein the control circuit causes the electric current resonant converter to operate in the full-bridge mode as the operating mode when the voltage detected by the input voltage detection circuit is higher than the first prescribed voltage and lower than a second prescribed voltage and causes the first rectification circuit to operate as a full-bridge rectification circuit without short-circuiting the target rectification element with the first switch, and
wherein the control circuit causes the electric current resonant converter to operate in the half-bridge mode as the operating mode when the voltage detected by the input voltage detection circuit is higher than the second prescribed voltage and causes the first rectification circuit to operate as a full-bridge rectification circuit without short-circuiting the target rectification element with the first switch.

In the power conversion device 401 according to the example of FIG. 9A, the prescribed voltage Vth1 and the prescribed voltage Vth2 are an example of the first prescribed voltage and an example of the second prescribed voltage, respectively.

### EXPLANATION OF REFERENCES

1, 301, 401, 601, 801, 901 Power conversion device
11, 611a to 611c AC power supply
12, 311, 612, 631a to 631c Resistor
31 Diode bridge
32, 51, 431, 651a to 651c, 671, 831 Inductor
33, 91, 92, 731, 732, 851 to 854 Diode
34, 53, 93, 432, 472, 652, 673, 733, 832, 833 Capacitor
52 Primary winding
71, 72, 411, 672, 711, 712, 811 Secondary winding
111, 111a Control circuit
131 Boost converter control circuit
132 Voltage detection circuit
133 Operating mode setting circuit
134 Electric current resonant converter drive circuit
151 Input voltage detection circuit
152 Output voltage detection circuit
211 NOT circuit
212 NOR circuit
213 OR circuit
310, 630a to 630c Inrush current limit circuit
312 Switch
451 to 454 Diode
471, 632a to 632c Switch
611 AC power supply unit
911 to 914, Q1, Q11 to Q14, Q101 to Q106, Q111 to Q114 MOSFET
3011, 3021, 3031, 3311, 3312 Voltage
3012, 3022, 3032 Drain current
3013, 3023, 3033, 3111, 3121, 3131 Switching loss
3112, 3122, 3132 Conduction loss
3211, 3212, 3221, 3222, 3411 to 3413, 3431 to 3433 Characteristic
3511 to 3512, 3521 to 3524 Signal
5011 Table
A1, A11, A21, A101, A111, A211 Power conversion system
B1, B11, B101 Boost converter
B2, B12, B102, B112, B212 Electric current resonant converter
TR1, TR11, TR101, TR111 Transformer

What is claimed is:

1. A power conversion device comprising:
a boost converter;
an electric current resonant converter connected to a stage subsequent to the boost converter; and
a control circuit,
wherein the boost converter boosts an input voltage to designate the boosted input voltage as an output voltage and output the output voltage while charging a first output capacitor with the output voltage,
wherein the control circuit controls the boost converter on the basis of a voltage detected by an output voltage detection circuit configured to detect a voltage of the first output capacitor,
wherein the control circuit sets the output voltage of the boost converter to a first output voltage level or a second output voltage level in accordance with a voltage detected by an input voltage detection circuit configured to detect a voltage corresponding to the input voltage, causes the electric current resonant converter to operate in a full-bridge mode as an operating mode when the first output voltage level has been set, and causes the electric current resonant converter to operate in a half-bridge mode as an operating mode when the second output voltage level has been set,
wherein the output voltage detection circuit and the input voltage detection circuit are a common circuit or separate circuits, and
wherein the first output voltage level or the second output voltage level is set at a predetermined timing after the input voltage is input and a set operating mode is maintained until a process of setting the first output voltage level or the second output voltage level is reset.

2. The power conversion device according to claim 1,
wherein the electric current resonant converter includes
a first leg in which a first switching element and a second switching element are connected in series;
a second leg in which a third switching element and a fourth switching element are connected in series;
a transformer having a primary winding and a secondary winding;
a first resonant inductor;
a first resonant capacitor; and
a first rectification circuit,
wherein, in a primary circuit of the transformer, the first leg and the second leg are connected in parallel and both ends of the primary winding are connected to two connection points, i.e., a connection point between the first switching element and the second switching element and a connection point between the third switching element and the fourth switching element, via the first resonant inductor and the first resonant capacitor,
wherein, in a secondary circuit of the transformer, both ends of the secondary winding are connected to an input end of the first rectification circuit, and
wherein, in the set operating mode, the first switching element, the second switching element, the third switching element, and the fourth switching element operate at a fixed frequency without a control process of feeding back an output from the secondary circuit.

3. The power conversion device according to claim 2,
wherein the first rectification circuit is a full-bridge rectification circuit, and
wherein, in the secondary circuit, the input end of the first rectification circuit and both ends of the secondary winding are connected via a second resonant inductor and a second resonant capacitor.

4. The power conversion device according to claim 3, wherein leakage inductance of the transformer is used as the first resonant inductor and the second resonant inductor.

5. The power conversion device according to claim 1,
wherein an inrush current limit circuit is provided within a path along which the first output capacitor is charged, and
wherein the control circuit decides a target boost voltage of the boost converter in accordance with a voltage detected by the input voltage detection circuit after an inrush current during activation is terminated and an inrush current limit of the inrush current limit circuit is canceled.

6. The power conversion device according to claim 1,
wherein the input voltage is a single- or three-phase alternating current (AC) voltage, and
wherein the boost converter is a power factor correction (PFC) converter configured to perform power factor improvement control.

7. The power conversion device according to claim 3,
wherein the first rectification circuit includes
a third leg in which a first rectification element and a second rectification element are connected in series; and
a fourth leg in which a third rectification element and a fourth rectification element are connected in series,
wherein the third leg and the fourth leg are connected in parallel and both ends of the secondary winding are connected to two connection points, i.e., a connection point between the first rectification element and the second rectification element and a connection point between the third rectification element and the fourth rectification element,
wherein the first rectification circuit is operable as a double-voltage rectification circuit by short-circuiting any one target rectification element of the first rectification element, the second rectification element, the third rectification element, and the fourth rectification element with a first switch, and
wherein the first switch is a semiconductor switch element or relay.

8. The power conversion device according to claim 7,
wherein the control circuit causes the electric current resonant converter to operate in the full-bridge mode as the operating mode when a voltage detected by the input voltage detection circuit is lower than a first prescribed voltage and causes the first rectification circuit to operate as the double-voltage rectification circuit by short-circuiting the target rectification element with the first switch,
wherein the control circuit causes the electric current resonant converter to operate in the full-bridge mode as the operating mode when the voltage detected by the input voltage detection circuit is higher than the first prescribed voltage and lower than a second prescribed voltage and causes the first rectification circuit to operate as a full-bridge rectification circuit without short-circuiting the target rectification element with the first switch, and
wherein the control circuit causes the electric current resonant converter to operate in the half-bridge mode as the operating mode when the voltage detected by the input voltage detection circuit is higher than the second prescribed voltage and causes the first rectification circuit to operate as a full-bridge rectification circuit without short-circuiting the target rectification element with the first switch.
